(19) United States
(12) Patent Application Publication
(10) Pub. No.: US 2025/0184722 A1
(43) Pub. Date: Jun. 5, 2025

(54) SECRET KEY FROM TRANSPORT BLOCK PAYLOAD DATA

(71) Applicant: QUALCOMM Incorporated, San Diego, CA (US)

(72) Inventors: Ahmed ELSHAFIE, San Diego, CA (US); Alexandros MANOLAKOS, Athens (GR); Hung Dinh LY, San Diego, CA (US)

(21) Appl. No.: 18/840,207

(22) PCT Filed: Jan. 31, 2023
(86) PCT No.: PCT/US2023/061677

§ 371 Date: Aug. 21, 2024

(30) Foreign Application Priority Data
Mar. 28, 2022 (GR) 20220100265

(51) Int. Cl. H04W 12/03; H04L 9/08; H04W 12/041

(52) U.S. Cl. CPC H04W 12/03; H04L 9/0861; H04W 12/041

(57) ABSTRACT

Disclosed are techniques for wireless communication. In an aspect, a user equipment (UE) may receive a plurality of transport blocks on a physical sidelink shared channel. The UE may decode one or more transport blocks of the plurality of transport blocks to provide decrypted payload data. The UE may select bits of the decrypted payload data based on bit selection criteria. The UE may generate a secret key using the selected bits of the decrypted payload data. The UE may receive encrypted configuration data. The UE may decrypt the encrypted configuration data using the secret key.

### CROSS-REFERENCE TO RELATED APPLICATIONS

The present application for patent claims the benefit of GR Application No. 20220100265, entitled “SECRET KEY FROM TRANSPORT BLOCK PAYLOAD DATA”, filed Mar. 28, 2022, and is a national stage application, filed under 35 U.S.C. § 371, of International Patent Application No. PCT/US2023/061677, entitled, “SECRET KEY FROM TRANSPORT BLOCK PAYLOAD DATA”, filed Jan. 31, 2023, both of which are assigned to the assignee hereof and are expressly incorporated herein by reference in their entirety.

### BACKGROUND OF THE DISCLOSURE

### 1. Field of the Disclosure

Aspects of the disclosure relate generally to wireless communications.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)) and other technical enhancements.

Leveraging the increased data rates and decreased latency of 5G, among other things, vehicle-to-everything (V2X) communication technologies are being implemented to support autonomous driving applications, such as wireless communications between vehicles, between vehicles and the roadside infrastructure, between vehicles and pedestrians, etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless communication performed by a user equipment (UE) includes receiving a plurality of transport blocks on a physical sidelink shared channel; decrypting one or more transport blocks of the plurality of transport blocks to provide decrypted payload data; selecting bits of the decrypted payload data based on bit selection criteria generating a secret key using the selected bits of the decrypted payload data; receiving encrypted configuration data; and decrypting the encrypted configuration data using the secret key.

In an aspect, a method of wireless communication performed by a user equipment (UE) includes selecting bits of unencrypted payload data of one or more transport blocks based on bit selection criteria; generating a secret key using the selected bits of the unencrypted payload data; encrypting configuration data using the secret key; and transmitting the encrypted configuration data.

In an aspect, a user equipment (UE) includes a memory; at least one transceiver; and at least one processor communicatively coupled to the memory and the at least one transceiver, the at least one processor configured to: receive, via the at least one transceiver, a plurality of transport blocks on a physical sidelink shared channel; decrypt one or more transport blocks of the plurality of transport blocks to provide decrypted payload data; select bits of the decrypted payload data based on bit selection criteria; generate a secret key using the selected bits of the decrypted payload data; receive, via the at least one transceiver, encrypted configuration data; and decrypt the encrypted configuration data using the secret key.

In an aspect, a user equipment (UE) includes a memory; at least one transceiver; and at least one processor communicatively coupled to the memory and the at least one transceiver, the at least one processor configured to: select bits of unencrypted payload data of one or more transport blocks based on bit selection criteria; generate a secret key using the selected bits of the unencrypted payload data; encrypt configuration data using the secret key; and transmit, via the at least one transceiver, the encrypted configuration data.

In an aspect, a user equipment (UE) includes means for receiving a plurality of transport blocks on a physical sidelink shared channel; means for decrypting one or more transport blocks of the plurality of transport blocks to provide decrypted payload data; means for selecting bits of the decrypted payload data based on bit selection criteria; means for generating a secret key using the selected bits of the decrypted payload data; means for receiving encrypted configuration data; and means for decrypting the encrypted configuration data using the secret key.

In an aspect, a user equipment (UE) includes means for selecting bits of unencrypted payload data of one or more transport blocks based on bit selection criteria; means for generating a secret key using the selected bits of the unencrypted payload data; means for encrypting configuration data using the secret key; and means for transmitting the encrypted configuration data.

In an aspect, a non-transitory computer-readable medium stores computer-executable instructions that, when executed by a user equipment (UE), cause the UE to: receive a plurality of transport blocks on a physical sidelink shared channel; decrypt one or more transport blocks of the plurality of transport blocks to provide decrypted payload data; select bits of the decrypted payload data based on bit selection criteria; generate a secret key using the selected bits of the decrypted payload data; receive encrypted configuration data; and decrypt the encrypted configuration data using the secret key.

In an aspect, a non-transitory computer-readable medium stores computer-executable instructions that, when executed by a user equipment (UE), cause the UE to: select bits of unencrypted payload data of one or more transport blocks based on bit selection criteria; generate a secret key using the selected bits of the unencrypted payload data; encrypt configuration data using the secret key; and transmit the encrypted configuration data.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A and 2B illustrate example wireless network structures, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIG. 4 illustrates basic transmission scenarios in accordance with certain aspects of the disclosure.

FIG. 5 illustrates basic sidelink deployment scenarios, according to aspects of the disclosure.

FIG. 6 shows an example resource pool in accordance with certain aspects of the disclosure.

FIG. 7 depicts an example configuration of symbols of a sidelink resource for a slot of a sub-channel, according to aspects of the disclosure.

FIG. 8 is a timing diagram showing an example of how sidelink (SL) resources may be allocated, according to aspects of the disclosure.

FIG. 9 is a diagram illustrating an example downlink positioning reference signal (DL-PRS) configuration for two transmission-reception points (TRPs) operating in the same positioning frequency layer, according to aspects of the disclosure.

FIG. 10 illustrates signals exchanged during an example single-phase round-trip-time (RTT) positioning procedure between two sidelink UEs, according to aspects of the disclosure.

FIG. 11 illustrates an example attack scenario, according to aspects of the disclosure.

FIG. 12 shows an example of the elements of a sidelink configuration/pre-configuration that may be secured by one or more secret keys (SKs), according to aspects of the disclosure.

FIG. 13 shows an example of the elements of a sidelink configuration/pre-configuration defining a separate positioning resource pool configuration that may be secured by one or more SKs, according to aspects of the disclosure.

FIG. 14 is a functional block diagram showing an example transmitting UE and receiving UE, according to aspects of the disclosure.

FIG. 15 shows an example message exchange between two UEs, according to aspects of the disclosure.

FIG. 16 shows an example bit selection operation using a selection bitmap, according to aspects of the disclosure.

FIG. 17 shows an example bit selection operation based on selection windows, according to aspects of the disclosure.

FIG. 18 illustrates an example method of wireless communication performed by a UE, according to aspects of the disclosure.

FIG. 19 illustrates an example method of wireless communication performed by a UE according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE), “vehicle UE” (V-UE), “pedestrian UE” (P-UE), and “base station” are not intended to be specific or otherwise limited to any particular radio access technology (RAT), unless otherwise noted. In general, a UE may be any wireless communication device (e.g., vehicle on-board computer, vehicle navigation device, mobile phone, router, tablet computer, laptop computer, asset locating device, wearable (e.g., smartwatch, glasses, augmented reality (AR)/virtual reality (VR) headset, etc.), vehicle (e.g., automobile, motorcycle, bicycle, etc.). Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as a “mobile device,” an “access terminal” or “AT,” a “client device,” a “wireless device,” a “subscriber device,” a “subscriber terminal,” a “subscriber station,” a “user terminal” or UT, a “mobile terminal,” a “mobile station,” or variations thereof.

A V-UE is a type of UE and may be any in-vehicle wireless communication device, such as a navigation system, a warning system, a heads-up display (HUD), an on-board computer, an in-vehicle infotainment system, an automated driving system (ADS), an advanced driver assistance system (ADAS), etc. Alternatively, a V-UE may be a portable wireless communication device (e.g., a cell phone, tablet computer, etc.) that is carried by the driver of the vehicle or a passenger in the vehicle. The term “V-UE” may refer to the in-vehicle wireless communication device or the vehicle itself, depending on the context. A P-UE is a type of UE and may be a portable wireless communication device that is carried by a pedestrian (i.e., a user that is not driving or riding in a vehicle). Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on Institute of Electrical and Electronics Engineers (IEEE) 802.11, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a NR Node B (also referred to as a gNB or gNodeB), etc. A base station may be used primarily to support wireless access by UEs including supporting data, voice and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an UL/reverse or DL/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference RF signals to UEs to be measured by the UEs and/or may receive and measure signals transmitted by the UEs. Such base stations may be referred to as positioning beacons (e.g., when transmitting RF signals to UEs) and/or as location measurement units (e.g., when receiving and measuring RF signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

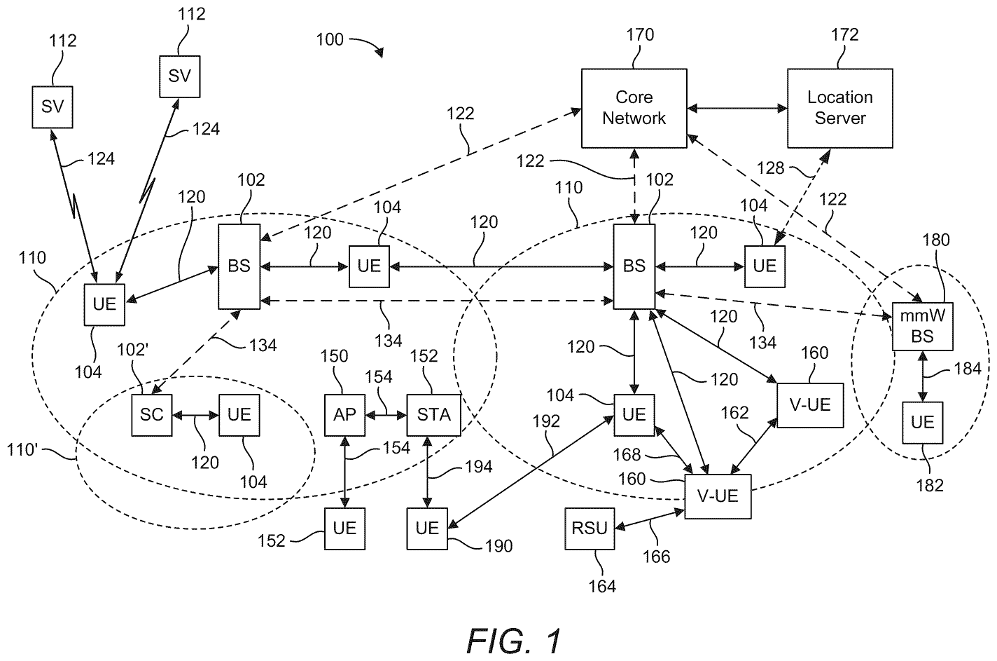

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations 102 may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization. RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both the logical communication entity and the base station that supports it, depending on the context. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labeled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a mmW base station 180 that may operate in millimeter wave (mmW) frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the EHF band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell.” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

Leveraging the increased data rates and decreased latency of NR, among other things, vehicle-to-everything (V2X) communication technologies are being implemented to support intelligent transportation systems (ITS) applications, such as wireless communications between vehicles (vehicle-to-vehicle (V2V)), between vehicles and the roadside infrastructure (vehicle-to-infrastructure (V2I)), and between vehicles and pedestrians (vehicle-to-pedestrian (V2P)). The goal is for vehicles to be able to sense the environment around them and communicate that information to other vehicles, infrastructure, and personal mobile devices. Such vehicle communication will enable safety, mobility, and environmental advancements that current technologies are unable to provide. Once fully implemented, the technology is expected to reduce unimpaired vehicle crashes by 80%.

Still referring to FIG. 1, the wireless communications system 100 may include multiple V-UEs 160 that may communicate with base stations 102 over communication links 120 using the Uu interface (i.e., the air interface between a UE and a base station). V-UEs 160 may also communicate directly with each other over a wireless sidelink 162, with a roadside unit (RSU) 164 (a roadside access point) over a wireless sidelink 166, or with sidelink-capable UEs 104 over a wireless sidelink 168 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, V2V communication, V2X communication (e.g., cellular V2X (cV2X) communication, enhanced V2X (eV2X) communication, etc.), emergency rescue applications, etc. One or more of a group of V-UEs 160 utilizing sidelink communications may be within the geographic coverage area 110 of a base station 102. Other V-UEs 160 in such a group may be outside the geographic coverage area 110 of a base station 102 or be otherwise unable to receive transmissions from a base station 102. In some cases, groups of V-UEs 160 communicating via sidelink communications may utilize a one-to-many (1:M) system in which each V-UE 160 transmits to every other V-UE 160 in the group. In some cases, a base station 102 facilitates the scheduling of resources for sidelink communications. In other cases, sidelink communications are carried out between V-UEs 160 without the involvement of a base station 102.

In an aspect, the sidelinks 162, 166, 168 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs.

In an aspect, the sidelinks 162, 166, 168 may be cV2X links. A first-generation of cV2X has been standardized in LTE, and the next generation is expected to be defined in NR. cV2X is a cellular technology that also enables device-to-device communications. In the U.S. and Europe, cV2X is expected to operate in the licensed ITS band in sub-6 GHz. Other bands may be allocated in other countries. Thus, as a particular example, the medium of interest utilized by sidelinks 162, 166, 168 may correspond to at least a portion of the licensed ITS frequency band of sub-6 GHz. However, the present disclosure is not limited to this frequency band or cellular technology.

In an aspect, the sidelinks 162, 166, 168 may be dedicated short-range communications (DSRC) links. DSRC is a one-way or two-way short-range to medium-range wireless communication protocol that uses the wireless access for vehicular environments (WAVE) protocol, also known as IEEE 802.11p, for V2V, V2I, and V2P communications. IEEE 802.11p is an approved amendment to the IEEE 802.11 standard and operates in the licensed ITS band of 5.9 GHz (5.85-5.925 GHz) in the U.S. In Europe, IEEE 802.11p operates in the ITS G5A band (5.875-5.905 MHz). Other bands may be allocated in other countries. The V2V communications briefly described above occur on the Safety Channel, which in the U.S. is typically a 10 MHz channel that is dedicated to the purpose of safety. The remainder of the DSRC band (the total bandwidth is 75 MHz) is intended for other services of interest to drivers, such as road rules, tolling, parking automation, etc. Thus, as a particular example, the mediums of interest utilized by sidelinks 162, 166, 168 may correspond to at least a portion of the licensed ITS frequency band of 5.9 GHz.

Alternatively, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Communications between the V-UEs 160 are referred to as V2V communications, communications between the V-UEs 160 and the one or more RSUs 164 are referred to as V2I communications, and communications between the V-UEs 160 and one or more UEs 104 (where the UEs 104 are P-UEs) are referred to as V2P communications. The V2V communications between V-UEs 160 may include, for example, information about the position, speed, acceleration, heading, and other vehicle data of the V-UEs 160. The V2I information received at a V-UE 160 from the one or more RSUs 164 may include, for example, road rules, parking automation information, etc. The V2P communications between a V-UE 160 and a UE 104 may include information about, for example, the position, speed, acceleration, and heading of the V-UE 160 and the position, speed (e.g., where the UE 104 is carried by a user on a bicycle), and heading of the UE 104.

Note that although FIG. 1 only illustrates two of the UEs as V-UEs (V-UEs 160), any of the illustrated UEs (e.g., UEs 104, 152, 182, 190) may be V-UEs. In addition, while only the V-UEs 160 and a single UE 104 have been illustrated as being connected over a sidelink, any of the UEs illustrated in FIG. 1, whether V-UEs, P-UEs, etc., may be capable of sidelink communication. Further, although only UE 182 was described as being capable of beam forming, any of the illustrated UEs, including V-UEs 160, may be capable of beam forming. Where V-UEs 160 are capable of beam forming, they may beam form toward each other (i.e., toward other V-UEs 160), toward RSUs 164, toward other UEs (e.g., UEs 104, 152, 182, 190), etc. Thus, in some cases. V-UEs 160 may utilize beamforming over sidelinks 162, 166, and 168.

The wireless communications system 100 may further include one or more UEs, such as UE 190, that connects indirectly to one or more communication networks via one or more device-to-device (D2D) peer-to-peer (P2P) links. In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (WiFi-D), Bluetooth®, and so on. As another example, the D2D P2P links 192 and 194 may be sidelinks, as described above with reference to sidelinks 162, 166, and 168.

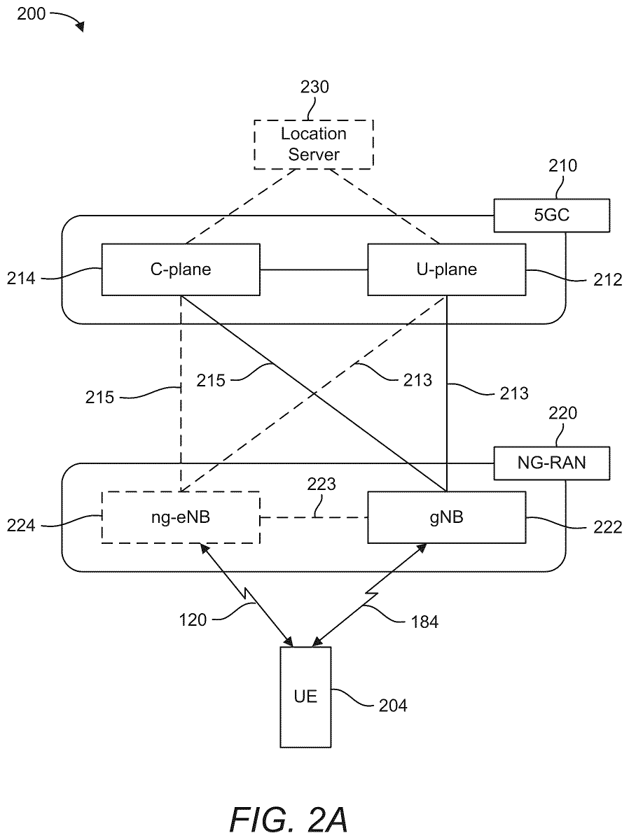

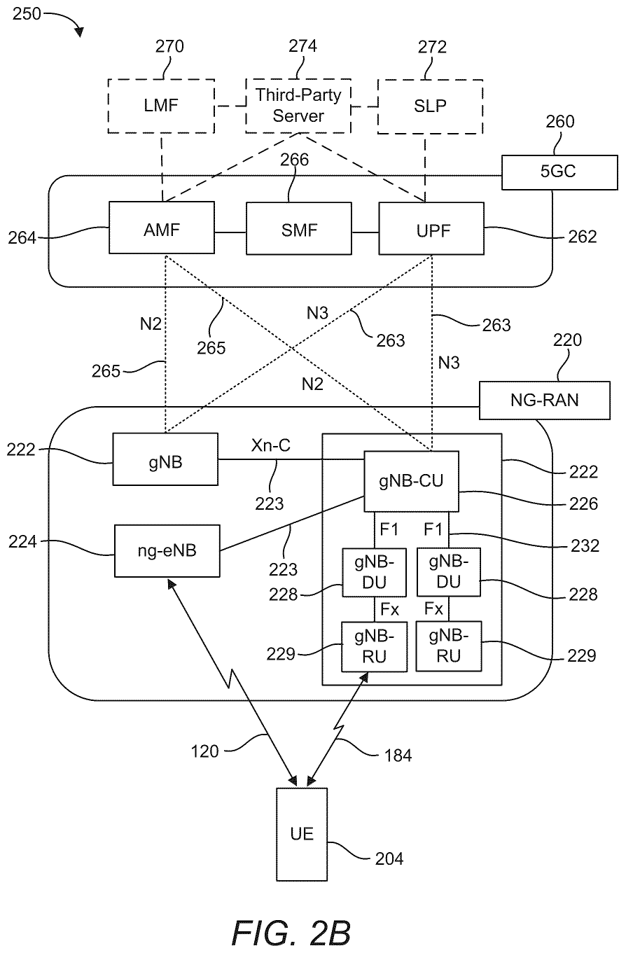

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, Internet Protocol (IP) routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third-party server, such as an original equipment manufacturer (OEM) server or service server).

FIG. 2B illustrates another example wireless network structure 250. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access network specific keys. The functionality of the AMF 264 also includes location services management for regulatory services, transport for location services messages between the UE 204 and a LMF 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP (Third Generation Partnership Project) access networks.

Functions of the UPF 262 include acting as an anchor point for intra-/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QoS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE IP address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the RRC, service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC. SDAP, and PDCP layers, with a gNB-DU 228 via the RLC and MAC layers, and with a gNB-RU 229 via the PHY layer.

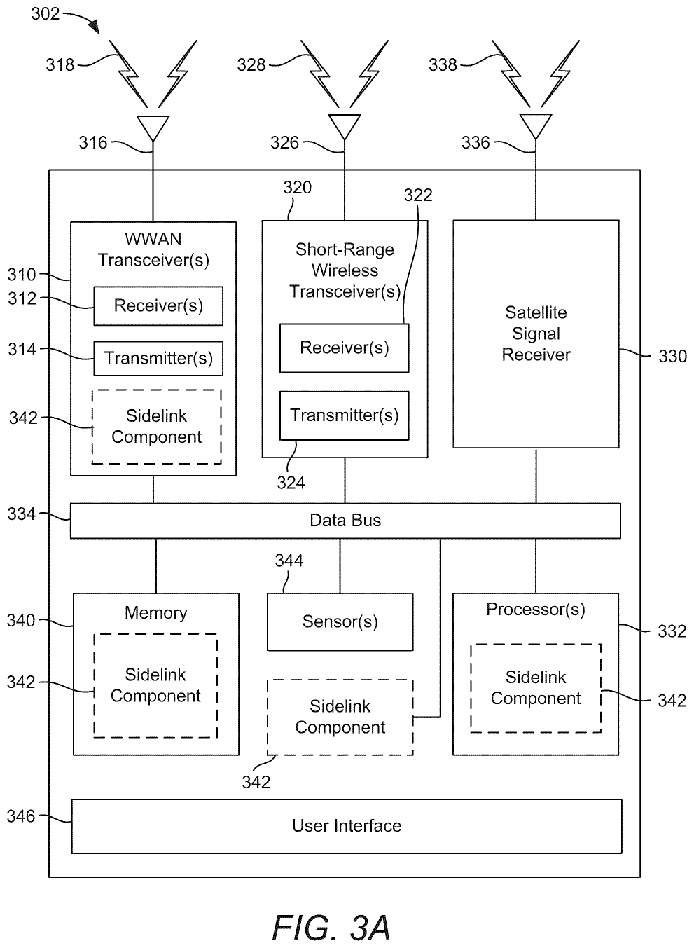

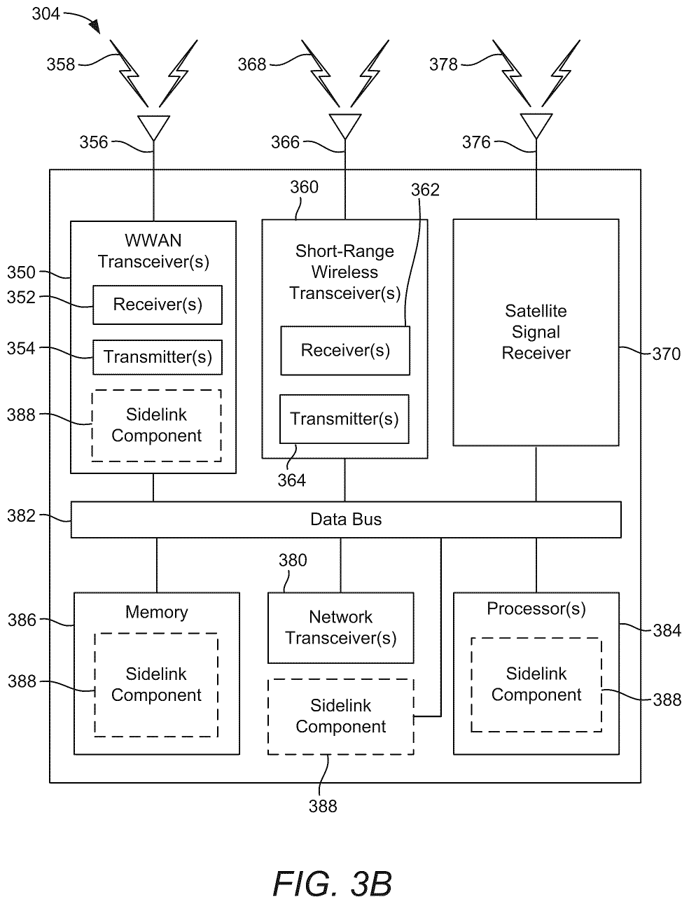

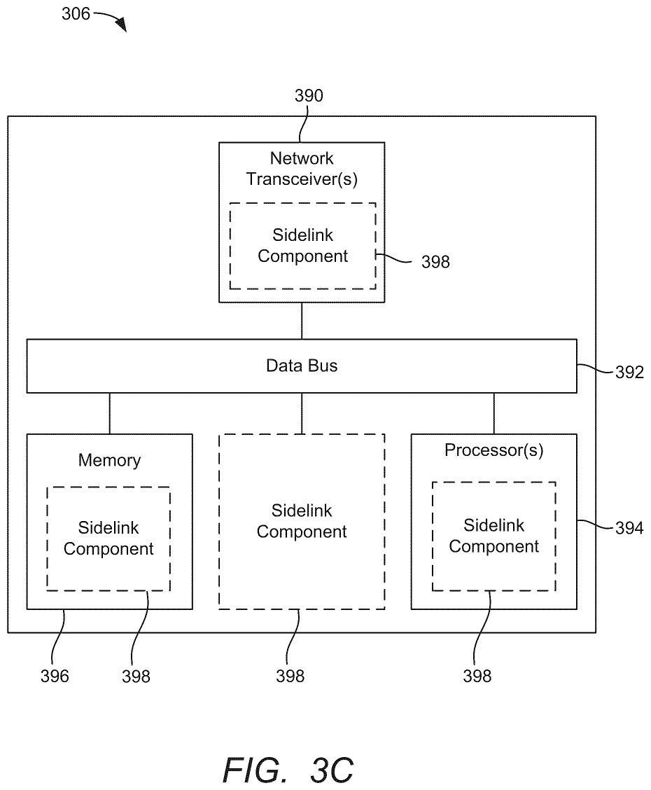

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., Wi-Fi, LTE-D, Bluetooth®, Zigbee®, Z-Wave®, PC5, DSRC, wireless access for vehicular environments (WAVE), near-field communication (NFC), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be Wi-Fi transceivers, Bluetooth®) transceivers, Zigbee® and/or Z-Wave® transceivers, NFC transceivers, or vehicle-to-vehicle (V2V) and/or vehicle-to-everything (V2X) transceivers.

The UE 302 and the base station 304 also include, at least in some cases, satellite signal receivers 330 and 370. The satellite signal receivers 330 and 370 may be connected to one or more antennas 336 and 376, respectively, and may provide means for receiving and/or measuring satellite positioning/communication signals 338 and 378, respectively. Where the satellite signal receivers 330 and 370 are satellite positioning system receivers, the satellite positioning/communication signals 338 and 378 may be GPS signals, global navigation satellite system (GLONASS) signals, Galileo signals, Beidou signals, Indian Regional Navigation Satellite System (NAVIC), Quasi-Zenith Satellite System (QZSS), etc. Where the satellite signal receivers 330 and 370 are NTN receivers, the satellite positioning/communication signals 338 and 378 may be communication signals (e.g., carrying control and/or user data) originating from a 5G network. The satellite signal receivers 330 and 370 may comprise any suitable hardware and/or software for receiving and processing satellite positioning/communication signals 338 and 378, respectively. The satellite signal receivers 330 and 370 may request information and operations as appropriate from the other systems, and, at least in some cases, perform calculations to determine locations of the UE 302 and the base station 304, respectively, using measurements obtained by any suitable satellite positioning system algorithm.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 332, 384, and 394, respectively, for providing functionality relating to, for example, wireless communication, and for providing other processing functionality. The processors 332, 384, and 394 may therefore provide means for processing, such as means for determining, means for calculating, means for receiving, means for transmitting, means for indicating, etc. In an aspect, the processors 332, 384, and 394 may include, for example, one or more general-purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include sidelink component 342, 388, and 398, respectively. The sidelink component 342, 388, and 398 may be hardware circuits that are part of or coupled to the processors 332, 384, and 394, respectively, that, when executed, cause the UE 302, the base station 304, and the network entity 306 to perform the functionality described herein. In other aspects, the sidelink component 342, 388, and 398 may be external to the processors 332, 384, and 394 (e.g., part of a modem processing system, integrated with another processing system, etc.). Alternatively, the sidelink component 342, 388, and 398 may be memory modules stored in the memories 340, 386, and 396, respectively, that, when executed by the processors 332, 384, and 394 (or a modem processing system, another processing system, etc.), cause the UE 302, the base station 304, and the network entity 306 to perform the functionality described herein. FIG. 3A illustrates possible locations of the sidelink component 342, which may be, for example, part of the one or more WWAN transceivers 310, the memory 340, the one or more processors 332, or any combination thereof, or may be a standalone component. FIG. 3B illustrates possible locations of the sidelink component 388, which may be, for example, part of the one or more WWAN transceivers 350, the memory 386, the one or more processors 384, or any combination thereof, or may be a standalone component. FIG. 3C illustrates possible locations of the sidelink component 398, which may be, for example, part of the one or more network transceivers 390, the memory 396, the one or more processors 394, or any combination thereof, or may be a standalone component.

The UE 302 may include one or more sensors 344 coupled to the one or more processors 332 to provide means for sensing or detecting movement and/or orientation information that is independent of motion data derived from signals received by the one or more WWAN transceivers 310, the one or more short-range wireless transceivers 320, and/or the satellite signal receiver 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a PDCP layer, a RLC layer, and a MAC layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 332. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 332, which implements Layer-3 (L3) and Layer-2 (L2) functionality.

In the uplink, the one or more processors 332 provides demultiplexing between transport and logical channels, packet reassembly, deciphering, header decompression, and control signal processing to recover IP packets from the core network. The one or more processors 332 are also responsible for error detection.

Similar to the functionality described in connection with the downlink transmission by the base station 304, the one or more processors 332 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or PC or laptop may have Wi-Fi and/or Bluetooth capability without cellular capability), or may omit the short-range wireless transceiver(s) 320 (e.g., cellular-only, etc.), or may omit the satellite signal receiver 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite receiver 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 334, 382, and 392, respectively. In an aspect, the data buses 334, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 334, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processors 332, 384, 394, the transceivers 310, 320, 350, and 360, the memories 340, 386, and 396, the sidelink component 342, 388, and 398, etc.

In some designs, the network entity 306 may be implemented as a core network component. In other designs, the network entity 306 may be distinct from a network operator or operation of the cellular network infrastructure (e.g., NG-RAN 220 and/or 5GC 210/260). For example, the network entity 306 may be a component of a private network that may be configured to communicate with the UE 302 via the base station 304 or independently from the base station 304 (e.g., over a non-cellular communication link, such as Wi-Fi).

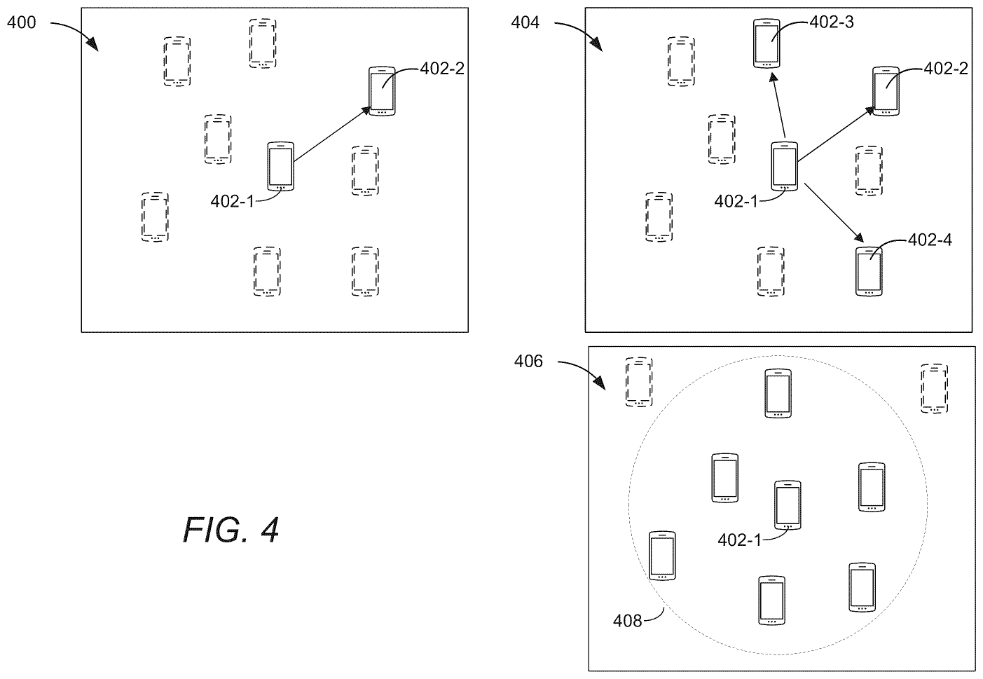

NR sidelink supports several basic transmission scenarios 1) unicast, in which case the sidelink transmission targets a specific receiving device, 2) groupcast, in which case the sidelink transmission targets a specific group of receiving devices, and 3) broadcast, in which case the sidelink transmission targets any device that is within the range of the transmission. FIG. 4 illustrates basic transmission scenarios in accordance with certain aspects of the disclosure. Transmission scenario 400 shows a unicast scenario in which UE 402-1 has targeted UE 402-2 for communication to the exclusion of other UEs in the environment. Transmission scenario 404 shows a group cast a scenario in which UE 402-1 has targeted UE 402-2, UE 402-3, and UE 402-4 for targeted communications. Transmission scenario 406 shows a broadcast scenario in which all UEs within the transmission range 408 of UE 402-1 are targeted for transmission.

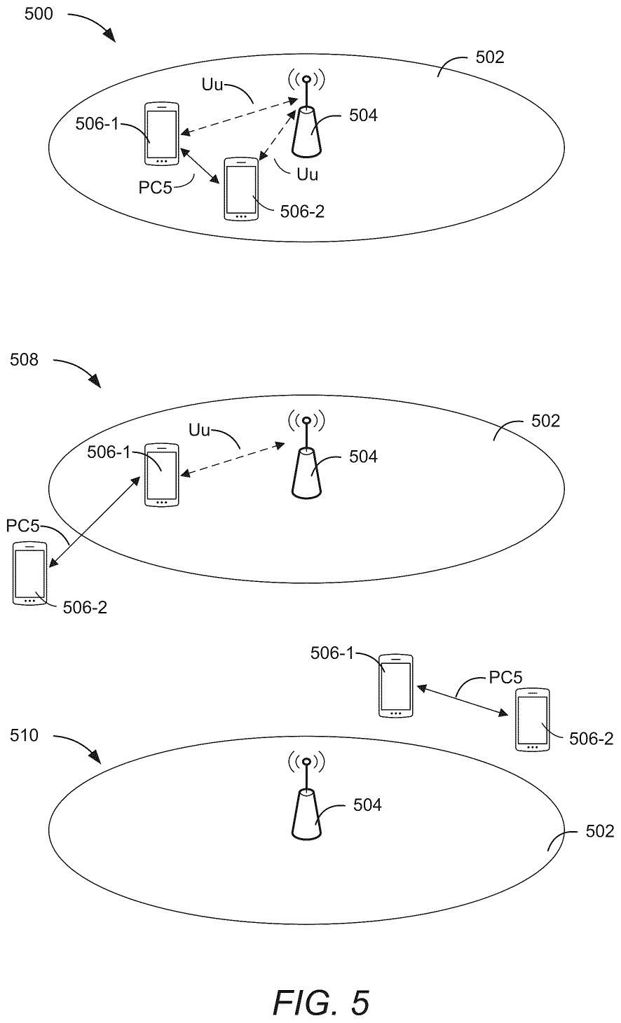

Generally, there are multiple deployment scenarios for NR sidelink communication in terms of the relation between the sidelink communication and an overlaid cellular network. FIG. 5 shows three such deployment scenarios in accordance with certain aspects of the disclosure. Deployment scenario 500 shows an in-coverage scenario in which both UE 506-1 and UE 506-2 are within the coverage 502 of a base station 504 and communicate with the base station 504 via Uu links. In deployment scenario 500, the UEs 506-1 and 506-2 communicate with one another via a PC5 link. To a smaller or larger extent, depending on the exact mode-of-operation of the UEs 506-1 and 506-2, the base station 504 may control the sidelink communications. Deployment scenario 508 shows a partial coverage scenario in which UE 506-1 is within coverage 502 and communicates with the base station 504 over a Uu link. In deployment scenario 508, the UEs 506-1 and 506-2 are within the communication range of one another and communicate via a PC5 link. In an aspect, UE 506-1 may act as a relay for communications between base station 504 and UE 506-2. Deployment scenario 510 shows out-of-coverage operation in which neither UE 506-1 nor UE 506-2 are within coverage 502 but are nevertheless within communication range of one another over a PC5 link.

Similar to downlink and uplink transmissions that take place over a Uu link, sidelink transmissions take place over a set of physical channels on to which a transport channel is mapped and/or which carry different types of L1/L2 control signaling. The physical channels include 1) a physical sidelink shared channel (PSSCH), 2) a physical sidelink control channel (PSCCH), 3) a physical sidelink broadcast channel (PSBCH), and 4) the physical sidelink feedback channel (PSFCH). The PSCCH carries control information in the sidelink. The PSSCH carries data payload in the sidelink and additional control information. The PSBCH carries information for supporting synchronization in the sidelink. PSBCH is sent within a sidelink synchronization signal block (S-SSB). The PSFCH carries feedback related to the successful or failed reception of a sidelink transmission.

Furthermore, NR sidelink communications support various signals, including reference signals, that are carried in or associated with the physical channels. In this regard, a demodulation reference signal (DMRS) is used by a sidelink receiver for decoding the associated sidelink physical channel, i.e., PSCCH, PSSCH, PSBCH. The DMRS is sent within the associated sidelink physical channel. A sidelink primary synchronization signal (S-PSS) and sidelink secondary synchronization signal (S-SSS) may be used by a sidelink receiver to synchronize to the transmitter of these signals. S-PSS and S-SSS are sent within the S-SSB. Sidelink channel state information reference signals (SL CSI-RS) are used for measuring channel state information (CSI) at the receiver that is then fed-back to the transmitter. The transmitter adjusts its transmission based on the fed-back CSI. SL CSI-RS is sent within the PSSCH region of the slot. Sidelink Phase-tracking reference signals (SL PT-RS) are used for mitigating the effect of phase noise (in particular at higher frequencies) resulting from imperfections of the oscillator. SL PT-RS is sent within the PSSCH region of the slot. Sidelink positioning reference signals (S-PRS) are used to conduct positioning operations to determine the absolute position of a sidelink device and/or the relative position of a sidelink device with respect to other sidelink devices. The S-PRS is sent within the PSSCH region of the slot.

In NR, only certain time and frequency resources are (pre-)configured to accommodate SL transmissions. The subset of the available SL resources is (pre-)configured to be used by several UEs for their SL transmissions. This subset of available SL resources is referred to as a resource pool.

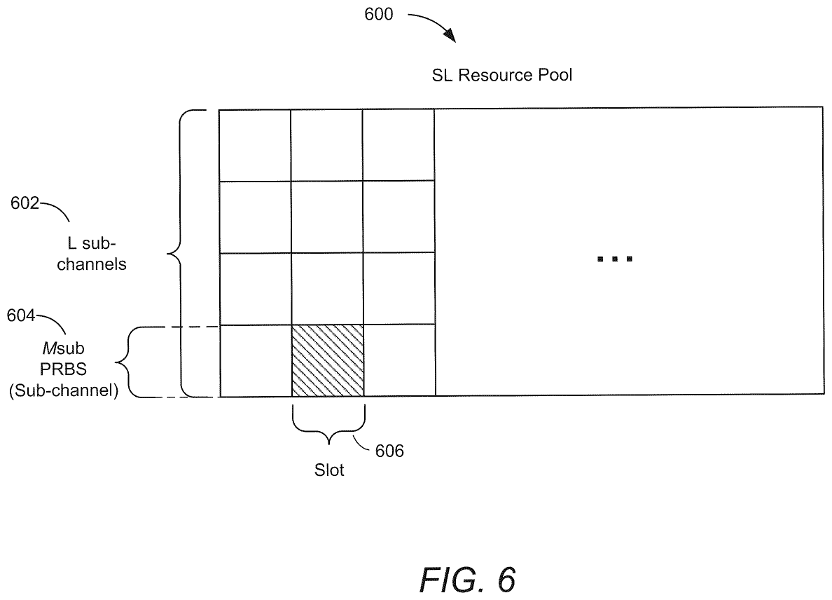

FIG. 6 shows an example resource pool 600 in accordance with certain aspects of the disclosure. A resource pool consists of contiguous physical resource blocks (PRBs) and contiguous or non-contiguous slots that have been (pre-)configured for SL transmissions. In the frequency domain, a resource pool is divided into a (pre-)configured number L of contiguous sub-channels 602, where a sub-channel 604 consists of a group of consecutive PRBs in a slot 606. The number Msub of PRBs in a sub-channel corresponds to the sub-channel size, which is (pre-)configured within the resource pool 600. In an aspect, the sub-channel size Msub can be equal to 10, 12, 15, 20, 25, 50, 75, or 100 PRBs. A sub-channel represents the smallest frequency domain unit for a sidelink data transmission or reception. A sidelink transmission can use one or multiple sub-channels. In the time domain, the slots that are part of a resource pool are (pre-)configured and occur on a periodic basis. In the example of FIG. 6, sidelink resources are shown as individual resource pool elements, where each resource element consists of a single slot 606 over a sub-channel 604 comprised of a set of common physical resource blocks (PRBS).

In an aspect, the slot 606 of a sub-channel only allocates a subset of its consecutive symbols (pre-)configured for sidelink communications. The subset of SL symbols per slot is indicated with a starting symbol and a number of consecutive symbols, where these two parameters are (pre-)configured per the resource pool. The number of consecutive SL symbols can vary between 7 and 14 symbols depending on the physical channels which are carried within a slot.

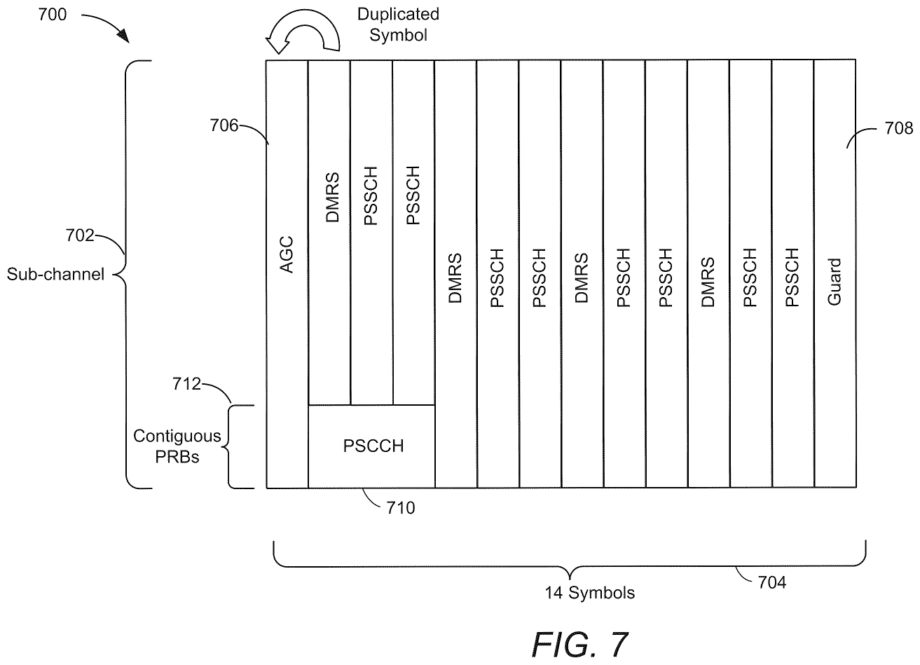

FIG. 7 depicts an example configuration of symbols of a SL resource 700 for a slot of a sub-channel in accordance with certain aspects of the disclosure. In this example, the configuration is directed to a single sub-channel 702 and a single slot 704. Here, slot 704 comprises 14 symbols including 3 PSCCH symbols and 12 PSSCH symbols. The example slot 704 includes 4 DMRS symbols which are carried in the PSSCH symbols. Among other data, the PSSCH carries the 1^{st}-stage sidelink control information (SCI) as discussed in further detail herein. The first symbol carried by each PRB of the SL resource 700 is an automatic gain control (AGC) symbol 706, which is used by the sidelink device for automatic gain control operations. In an aspect, the AGC symbol 706 may be a duplicate of the second symbol carried by each PRB of the sub-channel in 702. The last symbol carried by each PRB of the SL resource 700 is a guard symbol 708, which does not carry any sidelink data. The SL resource 700 includes a configurable number of contiguous PRBs and symbols for carrying the PSSCH 710. In this example, the PSSCH 710 is carried in the second, third, and fourth symbols of a plurality of contiguous PRBs 712.

With reference again to FIG. 7, the SL resource 700 can be shared by several UEs for their SL transmissions. The SL resources of the SL resource 700 can be used for all transmission types (i.e., unicast, groupcast, and broadcast). A UE can be (pre-) configured with multiple resource pools for transmission (e.g., transmit resource pools (RPs)) and with multiple resource pools for reception (e.g., receive resource RPs). A UE can receive data on resource pools used for SL transmissions by other UEs and transmit on the SL using its transmit RPs. In certain aspects, exceptional transmit RPs are configured for the UEs for situations that include when a UE is in a transition from idle to connected mode, when a UE experiences a link failure or a handover, or when a UE is changing between different configured transmit RPs. The use of exceptional transmit RPs in such situations aids in improving service continuity.

NR defines two resource allocation modes for sidelink communications, one centralized (Mode 1) and one distributed (Mode 2). In Mode 1, the base station (e.g., gNB) schedules sidelink resources to be used by the UE for sidelink transmissions. However, in Mode 2, the UE autonomously determines which sidelink resources of a resource pool the UE will use for transmissions.

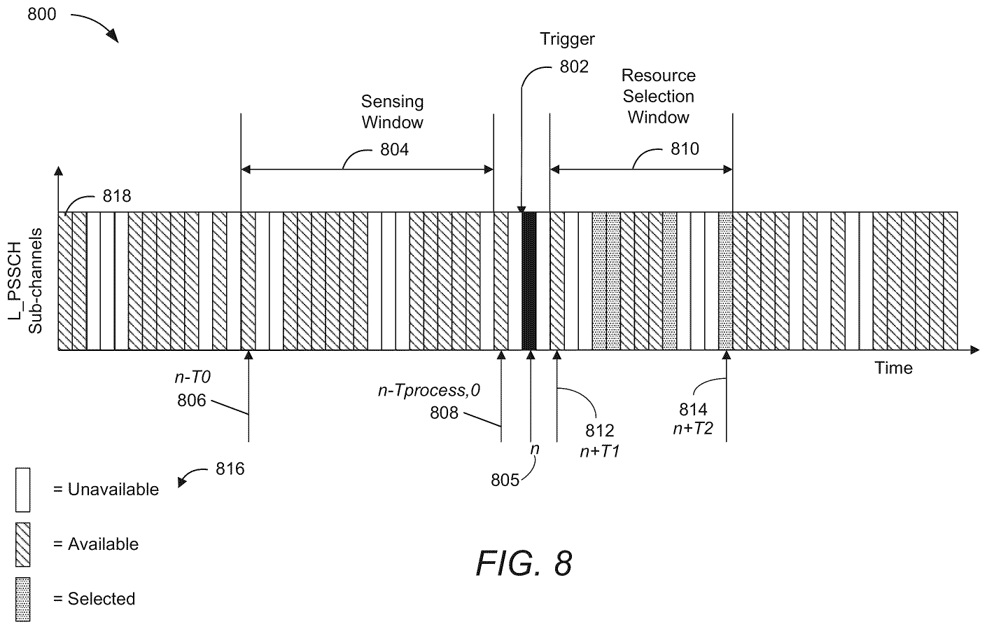

FIG. 8 is a timing diagram 800 showing an example of how SL resources may be allocated in accordance with certain aspects of the disclosure. In Mode 2, the UEs autonomously select their SL resources from a resource pool and can operate without network coverage, such as shown in the example scenario 510 of FIG. 5. The resource pool used by the UEs can be (pre-)configured by a gNB or eNB when the UE is in network coverage or pre-configured as part of the UE design.

Mode 2 uses sensing-based semi-persistent scheduling (SPS) for periodic traffic. The sensing procedure takes advantage of the periodic and predictable nature of basic sidelink service messages. In sensing-based SPS, the UEs reserve sub-channels in the frequency domain for a random number of consecutive periodic transmissions in the time domain. The number of slots for transmission and retransmissions within each periodic resource reservation period depends on the resource selection procedure. The number of reserved sub-channels per slot depends on the size of data to be transmitted.

The sensing-based resource selection procedure is composed of two stages: 1) a sensing procedure and 2) a resource selection procedure. In the example shown in FIG. 8, the procedures are executed in response to a trigger event 802. The trigger event 802 may coincide with a number of different event types. In certain aspects, the trigger event 802 may occur on a configurable periodic basis. In certain aspects, the trigger event 802 occurs when a particular task is executed by the UE, such as a positioning operation executed by the UE. A UE can also select new SL resources in response to a re-evaluation or pre-emption condition. For purposes of the following discussion, the resource allocation process originates at slot n 805, shown here as the first slot after the trigger event 802.

The sensing procedure is in charge of identifying the resources which are candidates for resource selection and is based on the decoding of the 1st-stage-SCI received from the surrounding UEs and on sidelink power measurements in terms of RSRP. The sensing procedure is performed during a sensing window 804, which is defined by a pre-configured parameter 7V and a specific parameter Tproc,0. The specific parameter Tproc,0 accounts for the time required by the UE to complete decoding the SCIs from other UEs and perform measurements on DMRS of signals transmitted on resources of the other UEs. As shown in FIG. 8, with respect to slot n 805, the UE will consider the sidelink RSRP measurements performed during the interval n−T0 806 to n−Tproc,0 808. Sidelink RSRP measurements can be computed using the power spectral density of the signal received in the PSCCH or in the PSSCH, for which the UE has successfully decoded the 1st-stage-SCI. PSCCH RSRP and PSSCH RSRP are determined as the linear average over the power contributions (in Watts) of the resource elements that carry the DMRS associated with PSCCH and PSSCH, respectively.

Based on the information extracted from the sensing operations, the resource selection procedure determines the resource(s) that the UE may use sidelink transmissions. For that purpose, another interval known as the resource selection window 810 is defined. The resource selection window 810 is defined by the interval n+T1 812 and n+T2 814, where T1 and T2 are two parameters that are determined by the UE implementation. In certain aspects, the value of T2 depends on a packet delay budget (PDB) and on an RRC pre-configured parameter called T2,min. In the case that PDB>T2 min, T2 is determined by the UE implementation and must meet the following condition: T2,min≤T2≤PDB. In the case that PDB≤T2,min, then T2=PDB. T1 is selected so that Tproc,1≤71, where Tproc,1 is the time required to identify the candidate resources and reserve a subset of resources for sidelink transmission.

The resource selection procedure is composed of two steps. First, the candidate resources within the resource selection window 810 are identified. A resource is indicated as a non-candidate if an SC is received on that slot or the corresponding slot is reserved by a previous SCI, and the associated sidelink RSRP measurement is above a sidelink RSRP threshold. The resulting set of candidate resources within the resource selection window 810 should be at least X % of the total resources within the resource selection window 810 to proceed with the second step of the resource selection process. The value of X is configured by RRC and, in certain aspects, can be 20%, 35% or 50%. If this condition is not met, the RSRP threshold may be increased by a predetermined amount, such as 3 dB, and the procedure is repeated. Second, the transmitting UE performs the resource selection from the identified candidate resources by reserving the selected resources in its SCI transmission. To exclude resources from the candidate pool based on sidelink measurements in previous slots, the resource reservation period (which is transmitted by the UEs in the 1st-stage-SCI) is introduced. As only the periodicity of transmissions can be extracted from the SCI, the UE that performs the resource selection uses this periodicity (if included in the decoded SCI) and assumes that the UE(s) that transmitted the SCI will do periodic transmissions with such a periodicity, during Q periods. This allows to identify and exclude the non-candidate resources of the resource selection window 810. In accordance with certain aspects of the disclosure,

$$Q = [ \frac{Tscal}{Prsvp} ] ,$$

where Prsvp refers to the resource reservation period decoded from the SCI, and Tscal corresponds to T2 converted to units of milliseconds (ms).

A sidelink resource, such as sidelink resource 818, is defined by one slot in time and L_{PSSCH} contiguous sub-channels in frequency. L_{PSSCH} is an integer in the range 1≤L_{PSSCH}≤max(L_{PSSCH}), where max(L_{PSSCH}) is the total number of sub-channels per slot in the resource selection window 810. However, in certain aspects, the value of max(L_{PSSCH}) can be modified by a congestion control process.

In the example resource allocation process of FIG. 8, T0=20 slots, Tproc,0=2 slots, T1=2 slots, and T2=16 slots. Once the resource selection is triggered at slot n, based on the measurements in the sensing window 804, the UE reserves sidelink resources within the resource selection window 810 for its own transmissions. Visual indicia corresponding to whether a sidelink resource is available, unavailable, or selected (e.g., reserved) in the example are shown in legend 816.

In accordance with certain aspects of the disclosure, the UE may reserve sidelink resources for itself as well as for other UEs. In certain aspects, the UE transmits one or more signals to other UEs indicating that the UE has reserved specific resources on behalf of the other UEs. In an aspect, other UEs would also monitor the resource pool for the PSCCH sent by the UE for the reservation. In accordance with certain aspects of the disclosure, the UE may reserve sidelink resources for transmitting its own sidelink PRS (SL-PRS) and request that other UEs transmit SL-PRS using the sidelink resources reserved by the UE on behalf of the other UEs. In such instances, the UE effectively schedules the SL-PRS resources that are to be used in positioning operations.

NR supports a number of cellular network-based positioning technologies, including downlink-based, uplink-based, and downlink-and-uplink-based positioning methods. Downlink-based positioning methods include observed time difference of arrival (OTDOA) in LTE, downlink time difference of arrival (DL-TDOA) in NR, and downlink angle-of-departure (DL-AoD) in NR. In an OTDOA or DL-TDOA positioning procedure, a UE measures the differences between the times of arrival (ToAs) of reference signals (e.g., positioning reference signals (PRS)) received from pairs of base stations, referred to as reference signal time difference (RSTD) or TDOA measurements, and reports them to a positioning entity. More specifically, the UE receives the identifiers (IDs) of a reference base station (e.g., a serving base station) and multiple non-reference base stations in assistance data. The UE then measures the RSTD between the reference base station and each of the non-reference base stations. Based on the known locations of the involved base stations and the RSTD measurements, the positioning entity (e.g., the UE for UE-based positioning or a location server for UE-assisted positioning) can estimate the UE's location.

For DL-AoD positioning, the positioning entity uses a measurement report from the UE of received signal strength measurements of multiple downlink transmit beams to determine the angle(s) between the UE and the transmitting base station(s). The positioning entity can then estimate the location of the UE-based on the determined angle(s) and the known location(s) of the transmitting base station(s).

Uplink-based positioning methods include uplink time difference of arrival (UL-TDOA) and uplink angle-of-arrival (UL-AoA). UL-TDOA is similar to DL-TDOA, but is based on uplink reference signals (e.g., SRS) transmitted by the UE to multiple base stations. Specifically, a UE transmits one or more uplink reference signals that are measured by a reference base station and a plurality of non-reference base stations. Each base station then reports the reception time (referred to as the relative time of arrival (RTOA)) of the reference signal(s) to a positioning entity (e.g., a location server) that knows the locations and relative timing of the involved base stations. Based on the reception-to-reception (Rx-Rx) time difference between the reported RTOA of the reference base station and the reported RTOA of each non-reference base station, the known locations of the base stations, and their known timing offsets, the positioning entity can estimate the location of the UE using TDOA.

For UL-AoA positioning, one or more base stations measure the received signal strength of one or more uplink reference signals (e.g., SRS) received from a UE on one or more uplink receive beams. The positioning entity uses the signal strength measurements and the angle(s) of the receive beam(s) to determine the angle(s) between the UE and the base station(s). Based on the determined angle(s) and the known location(s) of the base station(s), the positioning entity can then estimate the location of the UE.

Downlink-and-uplink-based positioning methods include enhanced cell-ID (E-CID) positioning and multi-round-trip-time positioning (also referred to as “multi-cell RTT” and “multi-RTT”). In an RTT procedure, a first entity (e.g., a base station or a UE) transmits a first RTT-related signal (e.g., a PRS or SRS) to a second entity (e.g., a UE or base station), which transmits a second RTT-related signal (e.g., an SRS or PRS) back to the first entity. Each entity measures the time difference between the ToA of the received RTT-related signal and the transmission time of the transmitted RTT-related signal. This time difference is referred to as a reception-to-transmission (Rx-Tx) time difference. The Rx-Tx time difference measurement may be made, or may be adjusted, to include only a time difference between nearest slot boundaries for the received and transmitted signals. Both entities may then send their Rx-Tx time difference measurement to a location server (e.g., an LMF 270), which calculates the round trip propagation time (i.e., RTT) between the two entities from the two Rx-Tx time difference measurements (e.g., as the sum of the two Rx-Tx time difference measurements). Alternatively, one entity may send its Rx-Tx time difference measurement to the other entity, which then calculates the RTT. The distance between the two entities can be determined from the RTT and the known signal speed (e.g., the speed of light). For multi-RTT positioning, a first entity (e.g., a UE or base station) performs an RTT positioning procedure with multiple second entities (e.g., multiple base stations or UEs) to enable the location of the first entity to be determined (e.g., using multilateration) based on distances to, and the known locations of, the second entities. RTT and multi-RTT methods can be combined with other positioning techniques, such as UL-AoA and DL-AoD, to improve location accuracy.

The E-CID positioning method is based on radio resource management (RRM) measurements. In E-CID, the UE reports the serving cell ID, the timing advance (TA), and the identifiers, estimated timing, and signal strength of detected neighbor base stations. The location of the UE is then estimated based on this information and the known locations of the base station(s).

To assist positioning operations, a location server (e.g., location server 230, LMF 270, SLP 272) may provide assistance data to the UE. For example, the assistance data may include identifiers of the base stations (or the cells/TRPs of the base stations) from which to measure reference signals, the reference signal configuration parameters (e.g., the number of consecutive slots including PRS, periodicity of the consecutive slots including PRS, muting sequence, frequency hopping sequence, reference signal identifier, reference signal bandwidth, etc.), and/or other parameters applicable to the particular positioning method. Alternatively, the assistance data may originate directly from the base stations themselves (e.g., in periodically broadcasted overhead messages, etc.). In some cases, the UE may be able to detect neighbor network nodes itself without the use of assistance data.

In the case of an OTDOA or DL-TDOA positioning procedure, the assistance data may further include an expected RSTD value and an associated uncertainty, or search window, around the expected RSTD. In some cases, the value range of the expected RSTD may be +/−500 microseconds (μs). In some cases, when any of the resources used for the positioning measurement are in FR1, the value range for the uncertainty of the expected RSTD may be +/−32 μs. In other cases, when all of the resources used for the positioning measurement(s) are in FR2, the value range for the uncertainty of the expected RSTD may be +/−8 μs.

A location estimate may be referred to by other names, such as a position estimate, location, position, position fix, fix, or the like. A location estimate may be geodetic and comprise coordinates (e.g., latitude, longitude, and possibly altitude) or may be civic and comprise a street address, postal address, or some other verbal description of a location. A location estimate may further be defined relative to some other known location or defined in absolute terms (e.g., using latitude, longitude, and possibly altitude). A location estimate may include an expected error or uncertainty (e.g., by including an area or volume within which the location is expected to be included with some specified or default level of confidence).

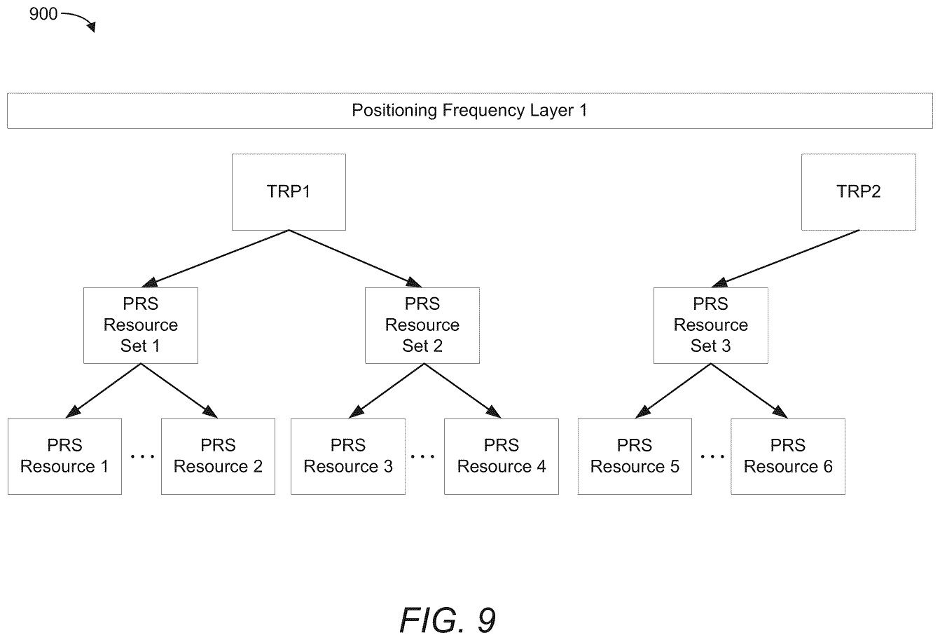

FIG. 9 is a diagram 900 illustrating an example PRS configuration for two TRPs (labeled “TRP1” and “TRP2”) operating in the same positioning frequency layer (labeled “Positioning Frequency Layer 1”), according to aspects of the disclosure. For a positioning session, a UE may be provided with assistance data indicating the illustrated PRS configuration. In the example of FIG. 9, the first TRP (“TRP1”) is associated with (e.g., transmits) two PRS resource sets, labeled “PRS Resource Set 1” and “PRS Resource Set 2,” and the second TRP (“TRP2”) is associated with one PRS resource set, labeled “PRS Resource Set 3” Each PRS resource set comprises at least two PRS resources. Specifically, the first PRS resource set (“PRS Resource Set 1”) includes PRS resources labeled “PRS Resource 1” and “PRS Resource 2,” the second PRS resource set (“PRS Resource Set 2”) includes PRS resources labeled “PRS Resource 3” and “PRS Resource 4,” and the third PRS resource set (“PRS Resource Set 3”) includes PRS resources labeled “PRS Resource 5” and “PRS Resource 6.”

Although FIG. 9 only shows two TRPs operating in the same positioning frequency layer, a UE can be configured with up to 4 Positioning Frequency Layers (PFL), each having up to 64 TRPs. In turn, each TRP can have up to two PRS resource sets in a PFL with up to 64 PRS resources per PRS resource set. As such, current standards a maximum number of 32768 PRS resources (4*64*2*64) in the assistance data for positioning. Such PRS configurations may be extended to sidelink positioning in which the TRPs include anchor sidelink devices and/or target sidelink devices.

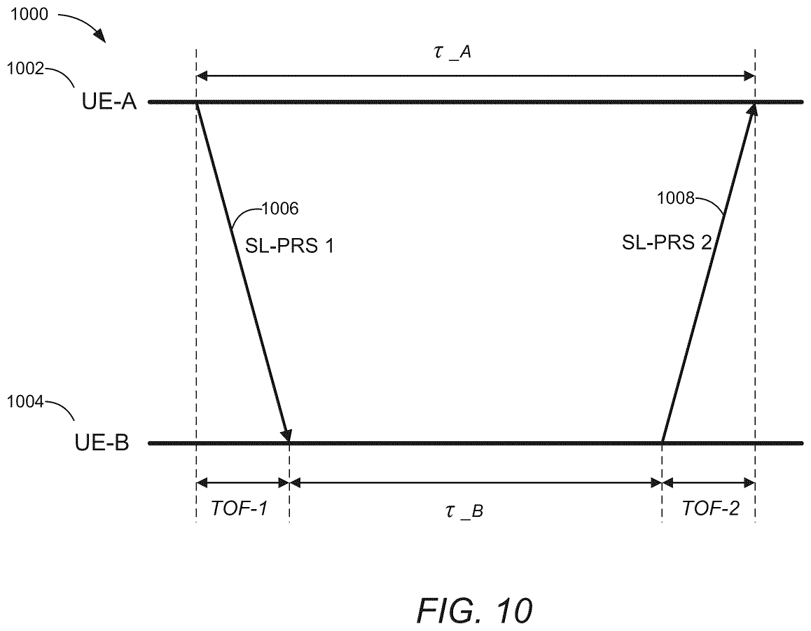

FIG. 10 illustrates signals exchanged during a single-phase RTT positioning procedure 1000 between two sidelink UEs in accordance with certain aspects of the disclosure. In this example, the positioning operations take place between UE-A 1002 and UE-B 1004, where UE-A 1002 transmits SL-PRS 1 1006, which is received by UE-B 1004 after a first time-of-flight duration TOF-1. After a time duration τ_B as measured by the UE-B's clock, UE-B 1004 transmits SL-PRS 2 1008, which is received by UE-A 1002 after a second time-of-flight TOF-2. In this example, the interval between the time at which UE-A 1002 transmits SL-PRS 1 1006 and the time at which it receives SL-PRS 2 1008 from UE-B 1004 as τ_A measured by UE-A's clock. Throughout the figures, any text in the figures following an underscore is understood to be formatted as a subscript and is expressed as a subscript in the text of this disclosure. As such, τ_B shown as τ_B and τ_A is shown as τ_B in FIG. 10.

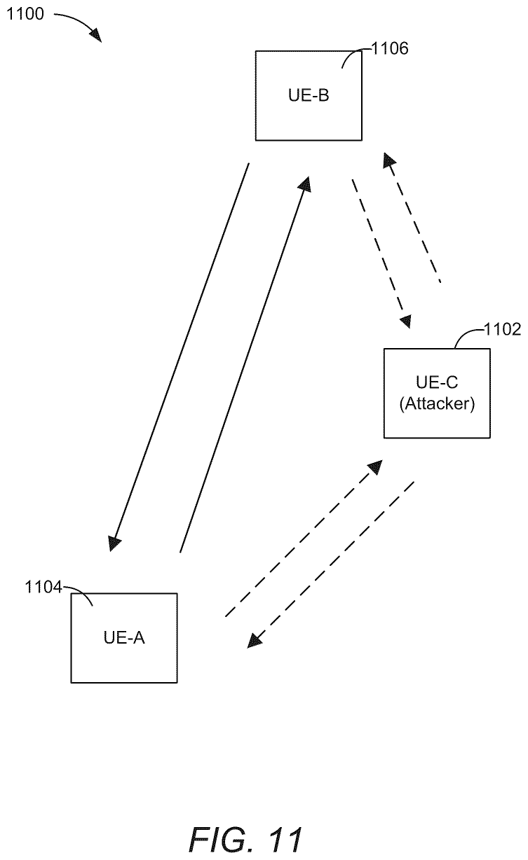

Sidelink positioning operations have security vulnerabilities. One such vulnerability is depicted in an example attack scenario 1100 shown in FIG. 11. In scenario 1100, an attacker UE-C 1102 attempts to disrupt positioning operations conducted between a first UE 1104 (labeled UE-A) and second UE 1106 (labeled UE-B). To this end, the attacker UE-C 1102 receives the full PRS resource configuration used by UE-A 1104 and UE-B 1106 to execute their positioning operations. As an example, the attacker UE-C 1102 may intercept the PRS resource configurations that are transmitted as assistance data in broadcast and/or groupcast transmissions, or in RRC data of groupcast and/or unicast transmissions. The attacker UE-C 1102 uses the intercepted PRS resource configuration to transmit false PRS on one or more of the configured PRS resources to one or both UE-A 1104 and/or UE-B 1106. UE-A 1104 and/or UE-B 1106 may measure the false PRS transmitted by the attacker UE-C 1102 as opposed to the true PRS transmitted by one or both UE-A 1104 and UE-B 1106, thereby resulting in erroneous positioning determinations. Additionally, or in the alternative, the attacker UE-C 1102 may transmit a jamming signal on one or more of the configured PRS resources, thereby preventing UE-A 1104 and UE-B 1106 from measuring the PRS transmitted by one or both UE-A 1104 and/or UE-B 1106.

To avoid attacks of the type described in scenario 1100, the PRS configuration as well as the PRS sequence may be secured (e.g., encrypted) with, for example, secret keys (SKs). In accordance with certain aspects of the disclosure, SKs may be generated for securing the PRS configuration/sequence without signaling the actual SK by leveraging the PSSCH payloads. In an aspect, SKs are generated based on selected bits of decrypted payload data of one or more transport blocks. In an aspect, the decrypted payload data from which the bits are selected includes decrypted layer 3 (L3) data since PSSCH/PC5-RRC are all L3 secured by upper-layers of the protocol stack. PC5-MAC-CE is not secured in accordance with 3GPP standards, but could be potentially secured by layer 2 (L2) in future standards or implementations, in which case L2 payload data may be decrypted for generating the SKs. Using the decrypted payload of transport blocks transmitted/received on secured layers provides another level of security for the SKs since the payload of the transport blocks are encrypted when transmitted on secured layers. Only when the payload has been properly decrypted are the bits of the payload used to generate the SKs.

In accordance with certain aspects of the disclosure, the decrypted payload data of transport blocks transmitted on the PSSCH, in addition to constituting payload data used by a sidelink device (e.g., anchor UE, the target UE, etc.) and/or base station for other data exchange purposes, is also used to generate SKs. To this end, one or more transport blocks of the plurality of transport blocks may be decrypted to provide the decrypted payload data. Bits of the decrypted payload data may be selected for generating the SK based on bit selection criteria, where the bit selection criteria is agreed upon between the devices that transmit and receive sidelink configuration information. The selected bits are used to generate SKs at the sidelink devices based on operations (e.g., use of the selected bits as the SK, providing the selected bits to a key derivation function to generate the SK, hashing the selected bits to generate the SK, use of the selected bits as a seed for a pseudo-random number generator to generate the SK, etc.) that are agreed upon between the transmitting and receiving devices. As such, each sidelink device locally generates the same SK without the need for exchanging the actual SKs in a separate communication. Devices transmitting the configuration information may encrypt the configuration data using the SK, while devices receiving the configuration information may decrypt the configuration data using the same SK.

The types of configuration data that may be secured using one or more SKs generated in accordance with certain aspects of the disclosure are varied. Examples of configuration data that may be encrypted using one or more SKs include 1) sidelink control information (SCI), 2) PSFCH configuration information, 3) sidelink resource pool configuration information, 4) sidelink positioning resource pool configuration information, 5) sidelink bandwidth part configuration information, 6) positioning assistance data, or 7) any combination of the foregoing.

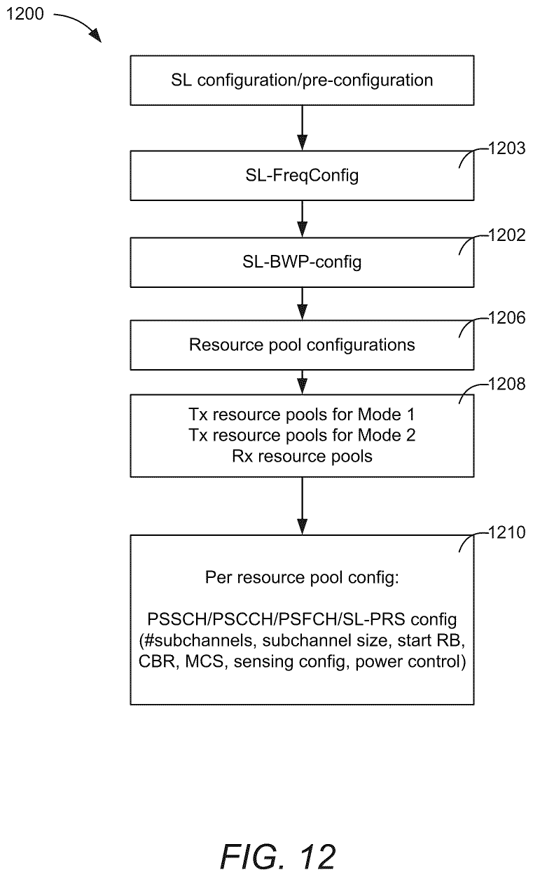

FIG. 12 shows an example of the elements of a sidelink configuration/pre-configuration 1200 that may be secured with one or more SKs, according to aspects of the disclosure. In this example, the sidelink bandwidth part (BWP) configuration 1202 is configured as part of the sidelink frequency configuration (SL-FreqConfig) 1203 and includes a plurality of resource pool configurations 1206. Example resource pool configurations are shown at block 1208 and may include transmission (Tx) resource pools for Mode 1 communications, transmission (Tx) resource pools for Mode 2 communications, and receive (Rx) resource pools. Each resource pool shown at block 1208 may include one or more of the example resource pool configurations shown at block 1210, including, for example, configurations for PSSCH, PSSCH, PSGCH, and SL-PRS. Each such configuration, in turn, may indicate the number of sub-channels, the sub-channel size, the start resource block (RB), the modulation coding scheme (MCS), the channel busy ratio (CBR), the sensing configuration, and the power control configuration. In this example, the PRS are reserved and transmitted in the PSSCH and are not part of a separate positioning resource pool.

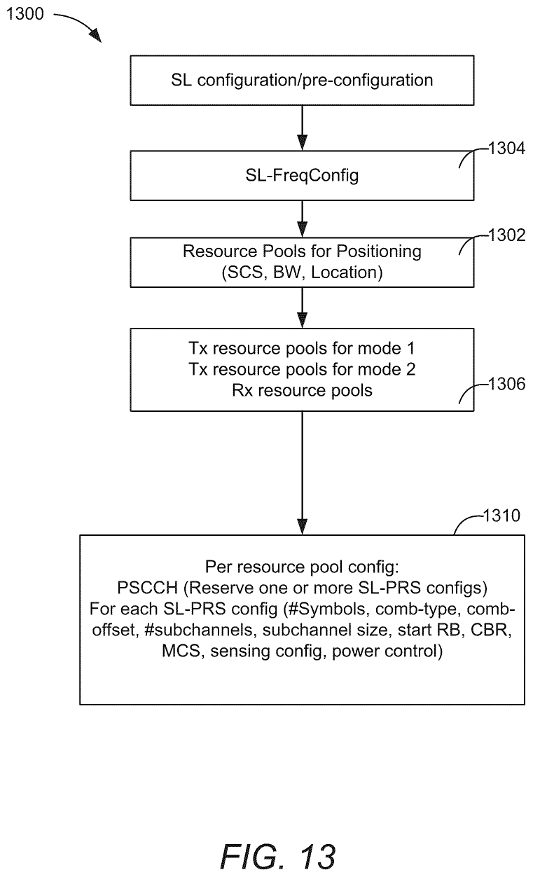

FIG. 13 shows an example of the elements of a sidelink configuration/pre-configuration 1300 having a separate positioning resource pool configuration that may be secured by one or more SKs, according to aspects of the disclosure. Unlike the example shown in FIG. 12, the resource pools for positioning 1302 are configured as part of the sidelink frequency configuration (SL-FreqConfig) 1304, not the BWP. The resource pools for positioning 1302 may each have their own subcarrier spacing (SCS), bandwidth (BW), and frequency location. Example parameters associated with the resource pools for positioning 1302 are shown at block 1306 and may include transmission (Tx) positioning resource pools for Mode 1 operation, transmission (Tx) positioning resource pools for Mode 2 operation, and receive (Rx) positioning resource pools. Each positioning resource pool shown at block 1306 may include one or more of the example resource pool configurations shown at block 1310, including, for example, reservations of sidelink PRS (SL-PRS) configurations in the PSSCH, where each SL-PRS configuration includes the number of symbols, the comb-type, the comb-offset, the number of sub-channels, the sub-channel size, and thus starting resource block. Each such configuration may also indicate the MCS, the CBR, the sensing configuration, and the power control configuration associated with the positioning resources.

The bit selection criteria for selecting which of the bits of the decrypted payload data of a transport block are used to generate the SKs are also varied. In certain aspects, the bit selection criteria may be known to the sidelink devices beforehand without an exchange of communications of the criteria between the sidelink devices (e.g., bit selection criteria based on a commonly held standard). Additionally, or in the alternative, the bit selection criteria may be communicated to the sidelink devices in RRC signaling transmitted by other sidelink devices or base stations. The bit selection criteria may include 1) an indication of one or more selected resource elements (REs) carrying data that, after being decrypted, includes the selected bits, 2) an indication of one or more selected RBs carrying data that, after being decrypted, includes the selected bits, 3) an indication of one or more selected resource block groups (RBGs) carrying data that, after being decrypted, includes the selected bits, 4) an indication of one or more selected symbol occurrences of one or more REs, RBs, or RBGs carrying data that, after being decrypted, includes the selected bits, 5) an indication of one or more selected slots of one or more REs, RBs, or RBGs carrying data that, after being decrypted, includes the selected bits, 6) an indication of one or more patterns corresponding to bits of the decrypted payload data that are to be used as the selected bits, 7) an indication of a bitmap pattern corresponding to which bits of the decrypted payload data are to be used as the selected bits, 8) an indication of one or more selected windows of the one or more transport blocks having data, that after being decrypted, includes the selected bits, 9) an indication of one or more start bit and length criteria corresponding to bits of the decrypted payload data are to be used as the selected bits, 10) an indication of which transport blocks of multiple transport blocks are to be used for selection of the selected bits, or 11) any combination thereof.

In certain aspects, a transmitting UE or base station can indicate to a receiving UE that the receiving UE is to use one or more of the indicated bit selection criteria with one or more previously transmitted TBs to generate the SK. The indication to use one or more of the indicated bit selection criteria may also come from the receiving UE, where the indication may also include an indication of which transport blocks previously transmitted by the transmitting UE or base station are to be used for SK generation.

In accordance with certain aspects of the disclosure, multiple SKs using the selected bits of the decrypted payload data may be generated. In an aspect, the same selected bits of the decrypted payload data may be used to generate the multiple SKs by providing the same selected bits to different key derivation functions, thereby generating different, unique SKs. In an aspect, different sets of the selected bits may be used to generate the multiple SKs. For example, the different sets of the selected bits may be provided to the same key derivation function (e.g., a generic key derivation function such as defined in Annex B.2 of 3GPP 133.220), where each set of the selected bits generates a unique SK. Additionally, or in the alternative, the bits of the different sets of selected bits may be used directly as the SKs provided the different sets include different bit patterns. Additionally, or in the alternative, a hybrid approach using a combination of the foregoing SK generation techniques may be used to generate multiple, unique SKs.

Different SKs of the multiple SKs may be used to encrypt/decrypt configuration data based on whether the configuration data is transmitted/received using a specific cast type. In an aspect, a first SK of the multiple SKs may be used when the encrypted configuration data is transmitted/received via a unicast transmission. Additionally, or in the alternative, a second SK of the multiple SKs may be used when the configuration data is transmitted/received via a groupcast transmission. Additionally, or in the alternative, a third SK of the multiple SKs may be used when the encrypted configuration data is transmitted/received via a broadcast transmission.

In an aspect, a base station (e.g., gNB) can define bit selection criteria using multiple bitmaps/patterns/windows per resource pool or across all resource pools and can signal the bit selection criteria to sidelink UEs via Uu RRC and/or MAC-CE (if MAC-CE is secured). A UE transmitting configuration information to receiving UEs can indicate which one of the bit selection criteria the receiving UEs are to use to generate the SKs. The UE transmitting the configurations can indicate the bit selection criteria to the receiving UEs via PC5-RRC/MAC-CE or 2^{nd}-stage sidelink control information (SCI-2).

In an aspect, a base station (e.g., gNB) can signal via RRC/MAC-CE/DCI or per resource pool configuration one or more seeds that can be used in a secure pseudo-random number generator to generate a sequence of locations within the transport block corresponding to bits that are to be used as an SK and/or used to generate an SK. In an aspect, a seed for each type of casting (e.g., seedgroupcast, seedunicast, seedbroadcast). In an aspect, a base station can configure multiple start-bits and lengths (SBLs) for bit selection from transport blocks. The SBL can change based on cast type as well.

In an aspect, UEs can agree on the bitmaps/patterns/seeds/SBLs that will be used as the bit selection criteria without the involvement of a base station. For example, a UE tasked with transmitting configurations can indicate the bit selection criteria to other UEs. The indication can be transmitted via PC5-RRC and/or PC5-MAC-CE. In an aspect, all or a portion of the criteria used as the bit selection criteria may be pre-configured (e.g., by standard), thereby reducing the resources needed by the UEs in configuring the bit selection criteria.

Resource pool configuration can also have a window defined such that UEs can use all PSSCHs received during the configured time window to get the SK, i.e., key derivation function (KDF) [key e.g., HMAC-SHA-256 (Key, [other parameters]), see Annex B.2.2 of TS 33.220 can be used such that KDF (TB1, TB2, . . . , TBK) where TB1 to TBK are TBs received within the defined window.

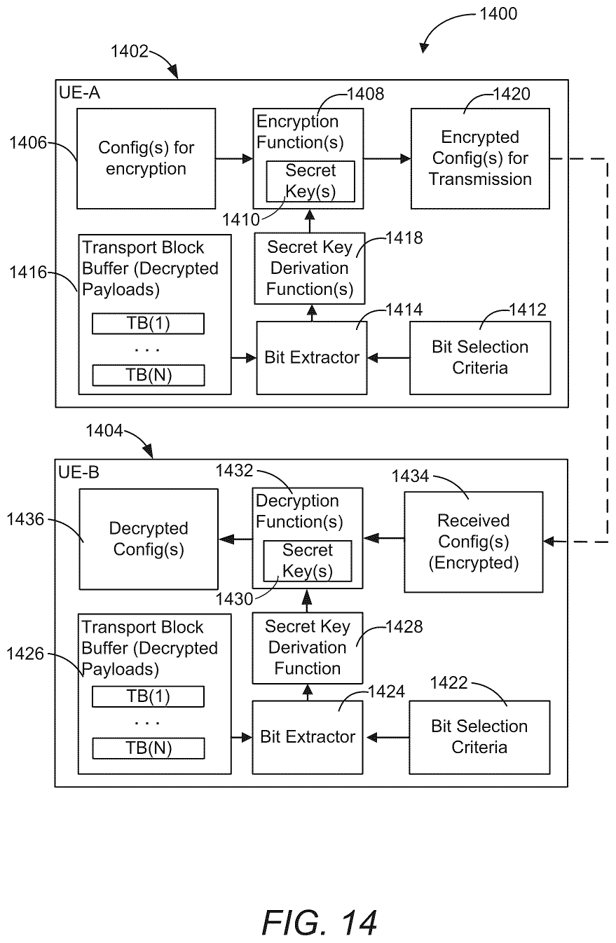

FIG. 14 is a functional block diagram 1400 showing an example transmitting UE-A 1402 and receiving UE-B 1404 in accordance with certain aspects of the disclosure. In this example, UE-A 1402 includes one or more configurations 1406 that are to be encrypted by one or more encryption function(s) 1408 using one or more SKs 1410. In accordance with certain aspects of the disclosure, the UE-A 1402 includes bit selection criteria 1412, such as the bit selection criteria described herein, which are used by a bit extractor function 1414 to select bits from one or more TBs, labeled TB(1) through TB(N), stored in a transport block buffer 1416 to generate the one or more SKs 1410.

In accordance with certain aspects of the disclosure, the transport block buffer 1416 may selectively store only PSSCH data received during one or more specified time windows. In an aspect, the bits of all PSSCH data received during the one or more specified time windows may be used as the SK or to generate the SK. In an aspect, only certain of the PSSCH data received during the one or more specified time windows are selected for use as the SK or to generate the SK based on the bit selection criteria.

In accordance with certain aspects of the disclosure, the transport blocks TB(1) through TB(N) include payload data received from one or more base stations and/or one or more UEs (e.g., UE-B 1404 or other sidelink UEs). Additionally, or in the alternative, the transport blocks TB(1) through TB(N) include payload data generated at UE-A 1402 for communicating information to one or more receiving UEs (e.g., UE-B 1404). In this example, the bit extractor function 1414 provides the selected bits to the input of one or more SK derivation functions 1418, which generate the SKs 1410 using the selected bits. In an aspect, the encryption functions 1408 use the SKs 1410 to generate encrypted configuration data 1420 from the configurations 1406. In turn, the encrypted configurations 1420 are transmitted to one or more UEs via unicast transmissions, groupcast transmissions, and/or broadcast transmissions. As noted herein, different SKs of the one or more SKs 1410 may be used to generate the encrypted configuration data 1420 based on whether the encrypted configuration data 1420 is to be transmitted via unicast transmissions, groupcast transmissions, broadcast transmissions, or any combination thereof.

The transport blocks TB(1) through TB(N) include payload data that is intended to convey information to the receiving UEs without an intent to convey a specific bit sequence that is to be used for generating the SKs. In such instances, the payload data is effectively used for information transfer while selected bits of the payload data are used for SK generation, thereby obviating the need to exchange the actual values of the SK(s) in a separate transmission or on separate transmission resources. Instead, the bits of the data payload are re-used as bits for SK generation.

In accordance with certain aspects of the disclosure, the configurations 1406 may include data for various sidelink configurations that, if left unsecured, could render the sidelink communications vulnerable to third-party attacks. In certain aspects, different types of configuration data of the configurations 1406 may be encrypted with the same or different SKs. As an example, a bandwidth part (BWP) may contain multiple configurations for separately configuring receiving and transmitting resource pools, where physical layer channels are configured per resource pool. In an aspect, all resource pools/physical channels may be encrypted/decrypted with the same SK. Alternatively, different resource pools/physical channels may be encrypted/decrypted with different SKs. In another aspect, the UEs may be configured with dedicated positioning resource pools. In an aspect, all positioning resource pools may be encrypted/decrypted with the same SK. Alternatively, different positioning resource pools may be encrypted/decrypted with different SKs.

As shown in FIG. 14, UE-B 1404 also employs bit selection criteria 1422 that is used by a bit extractor function 1424 to select bits of the decrypted payload data of one or more transport blocks TB(1) through TB(N) stored in a transport block buffer 1426. In this example, the bits selected by the bit extractor function 1424 are provided to one or more SK derivation functions 1428, which generate one or more SKs 1430. One or more decryption functions 1432 use the SKs 1430 to generate one or more decrypted configurations 1436 corresponding to the encrypted configurations 1434 received from UE-A 1402. In turn, the decrypted configurations 1436 are used to configure the resources used by UE-B 1404 in sidelink operations (e.g., positioning operations). In this example, the bit selection criteria 1422, the decrypted payload data in transport block buffer 1426, and the SK derivation functions 1428 used to generate the SKs 1430 at UE-B 1404 are the same as the bit selection criteria 1412, the decrypted payload data in transport block buffer 1416, and the SK derivation functions 1418 used to generate the SKs 1410 at UE-A 1402. As such, the SKs 1430 generated at UE-B 1404 are the same as the SKs 1410 generated at UE-A 1402. The decryption functions 1432 used to decrypt the received encrypted configurations 1434 at UE-B 1404 are inverse functions to the encryption functions 1408 used to encrypt the configurations 1406 at UE-A 1402.

In accordance with certain aspects of the disclosure, the size of the transport block buffer 1416 and the size of transport block buffer 1426 may not be the same. Accordingly, the number of prior transport blocks available to UE-B 1404 from which bits may be selected for generation of the SKs may not be the same as the number of prior transport blocks available to UE-A 1402. As such, in accordance with certain aspects of the disclosure, UE-A 1402 and UE-B 1404 may exchange transport block storage capabilities to ensure that the transport block payload data used at UE-A 1402 to generate the SKs is also available at UE-B 1404. In certain aspects, the transport block storage capabilities that are exchanged may also include an indication of the manner in which old payload data is removed from the respective transport block buffers 1416 and 1426. As an example, UE-A 1402 may indicate that specified transport blocks, a specified number of transport blocks, and/or a specified number of bits will not be used (e.g., flushed from the respective transport buffers 1416, 1426) for bit selection after the lapse of specified periods of time. In an aspect, a UE can indicate its bit/TB discarding rate (e.g., how many bits/TBs are discarded per unit of time). Additionally, or in the alternative, the indication used to describe how the old payload data of prior TBs is removed or discarded may be expressed in relation to storage of the encrypted TB payload prior to its decryption and storage in transport block buffer 1426.

In accordance with certain aspects of the disclosure, UE-A 1402 and UE-B 1404 may exchange or otherwise be pre-configured with SK scheduling information. Examples of SK scheduling information include 1) the times at which certain transport buffers are to be used to generate the SKs, 2) the times at which certain bit selection criteria are to be used to generate the SKs, 3) the times at which certain SK derivation functions are to be used to generate the SKs, 4) the times at which certain encryption/decryption functions are to be used with the generated SKs, 5) the times at which certain SKs are to be used to encrypt/decrypt the configurations, or 6) any combination of the foregoing. It will be recognized, based on the teachings of the present disclosure, that other timing arrangements for SK generation and encryption/decryption operations may be employed, the foregoing constituting non-limiting examples.

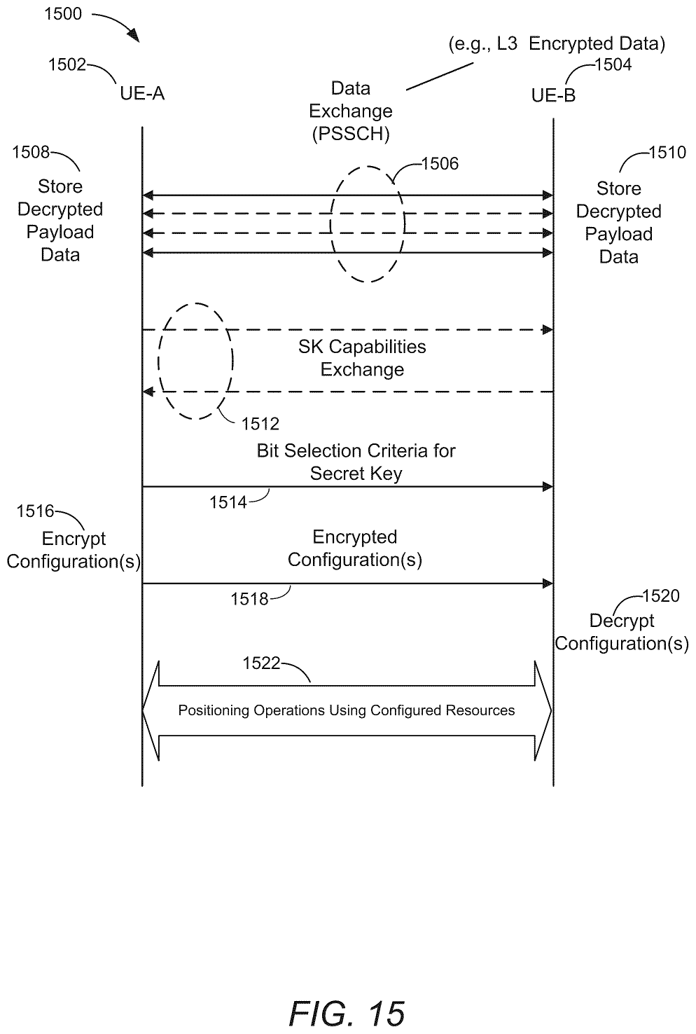

FIG. 15 shows an example message exchange 1500 between two UEs in accordance with certain aspects of the disclosure. In this example, the exchange occurs between a first UE-A 1502 that operates to send encrypted configurations for decryption and use at a second UE-B 1504. At operation 1506, UE-A 1502 and UE-B 1504 either exchange transport block payloads with one another and/or receive the same transport block payloads from another device (e.g., another sidelink device, one or more base stations, etc.). UE-A 1502 stores the decrypted payload data at operation 1508, and UE-B 1504 stores the decrypted payload data at operation 1510. As such, both UE-A 1502 and UE-B 1504 have the same decrypted payload data from which bits may be selected for generating SKs.

In accordance with certain aspects of the disclosure. UE-A 1502 and UE-B 1504 may optionally exchange SK capabilities at operation 1512. Such capabilities may include 1) transport block payload storage capabilities, 2) transport block storage payload flush configuration, 3) encryption/decryption function capabilities (e.g., which encryption/decryption functions are available at the UEs), 4) SK derivation function capabilities (e.g., which SK derivation functions can be executed by the UEs), or 5) any combination of the foregoing. It will be recognized, based on the teachings of the present disclosure, that other SK capabilities may be exchanged, the foregoing constituting non-limiting examples.

In the example shown in FIG. 15, UE-A 1502 is tasked with encrypting and transmitting sidelink configuration information. At operation 1514, UE-A 1502 transmits the bit selection criteria for selecting the bits of the decrypted transport block payloads that are to be used to generate the SKs. Additionally, or in the alternative, UE-A 1502 transmits other information relating to the generation and use of the SKs. Such information may include SK scheduling information, indications of encryption/decryption algorithms used, indications of SK derivation functions used, an indication of a time delay between generating a SK from a transport block and using the SK for encryption/decryption operations (e.g., at time t, select bits of the payload data from the transport block occurring at time t−x to generate the SK), etc. In turn, UE-B 1504 uses the received bit selection criteria, along with any additional information conveyed by UE-A 1502 to generate the SKs.

UE-A 1502 encrypts the configuration information at operation 1516 and transmits the encrypted configuration to UE-B 1504 at operation 1518. At operation 1520, UE-B 1504 decrypts the received encrypted configurations using the SKs that it generated based on the decrypted transport block payload data and bit selection criteria. In the example shown in FIG. 15, it is assumed that the encrypted configurations include PRS configurations used in positioning operations. With both UE-A 1502 and UE-B 1504 properly configured with the PRS configurations, positioning operations using the configured resources are executed at operation 1522.

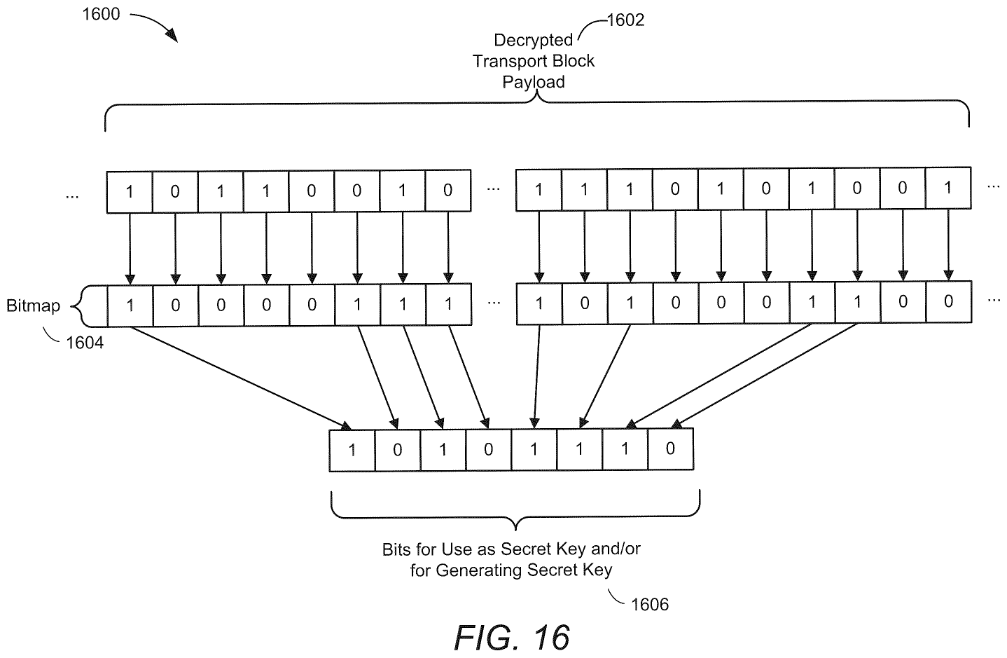

As noted, the bits of the transport block payload selected for SK generation may be based on a bitmap or other bit pattern criteria. FIG. 16 shows an example bit selection operation 1600 using a selection bitmap in accordance with certain aspects of the disclosure. In this example, the UE retrieves the decrypted transport block payload 1602 that is to be used for SK generation and aligns the bits of the decrypted transport block payload 1602 with a selection bitmap 1604. In an aspect, the selection bitmap 1604 may include the same number of bits as the decrypted transport block payload 1602 or fewer bits than the decrypted transport block payload 1602. If the selection bitmap 1604 is smaller than the transport block payload 1602, the selection bitmap 1604 may be indicated with a specific start/end bit of the decrypted transport block payload 1602 with which it is to be aligned.

The selection bitmap 1604 includes individual bits having values indicating whether the corresponding bits of the decrypted transport block payload are to be used (e.g., a value of 1) or ignored (e.g., a value of 0) in the bit selection operation. The bit selection operations of the illustrated example result in a bit sequence 1606, shown here as 10101110, which is used to generate one or more SKs as described herein.

It will be recognized that various combinations of bitmaps and transport blocks may be used to select the bits used to generate the SKs. In an aspect, a single selection bitmap may be used with a single transport block or with multiple transport blocks. In an aspect, multiple selection bitmaps may be used with a single transport block or multiple transport blocks. Based on the teachings of the present disclosure, it will be recognized that other selection bitmap configurations may be used to establish the bit selection criteria.

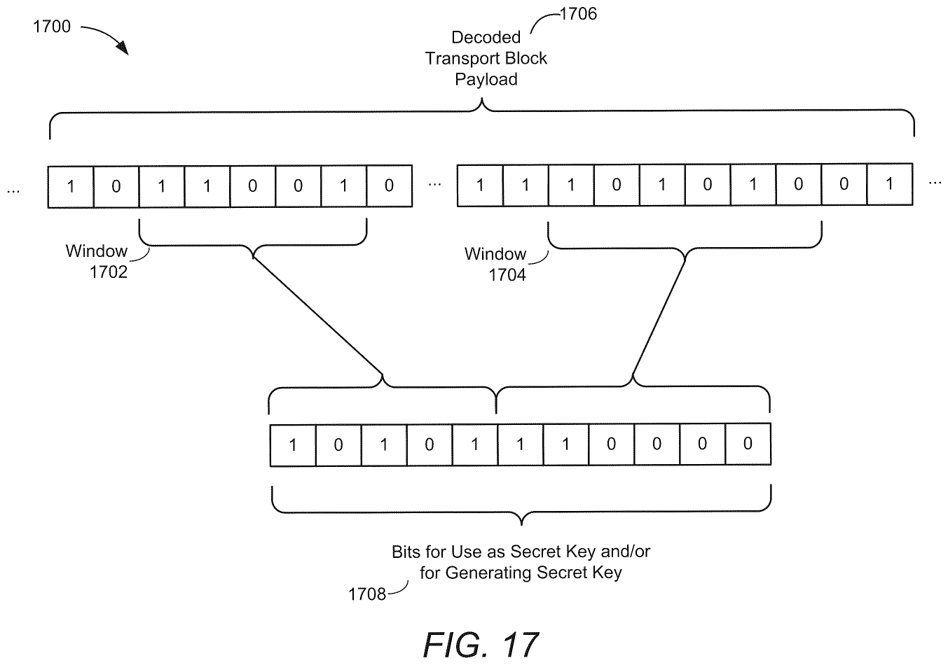

As also noted, the bits of the decrypted transport block payload selected for SK generation may be based on data occurring during various windows within the transport block payload. FIG. 17 shows an example bit selection operation 1700 based on windows in accordance with certain aspects of the disclosure. In this example, the bits selected for SK generation are extracted from two windows 1702 and 1704 of the decrypted transport block payload 1706. The corresponding selection operation results in a bit sequence 1708 of 10101110000 in this example.

Single or multiple windows may be indicated for the bit selection criteria. In an aspect, the windows may be indicated by a start bit location and length. In an aspect, the windows may be indicated by symbol positions within the decrypted transport block payload 1706, where only data bits associated with symbols at certain portions of the decrypted transport block payload 1706 are designated for selection. In an aspect, the windows may be indicated by start and end times within the decrypted transport block payload. In an aspect, the windows may be indicated by start and end times of PSSCH transmissions. In an aspect, the same selection window may be applied to multiple transport blocks. In an aspect, different selection windows may be applied to different transport blocks of multiple transport blocks. Based on the teachings of the present disclosure, it will be recognized that other windows selection configurations may be used to establish the bit selection criteria.

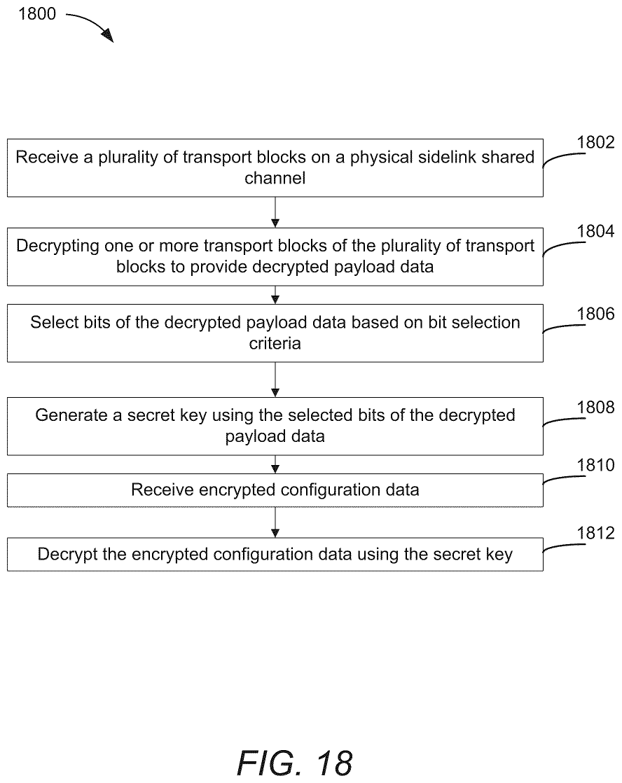

FIG. 18 illustrates an example method 1800 of wireless communication performed by a UE according to aspects of the disclosure. At operation 1802, the UE receives a plurality of transport blocks on a physical sidelink shared channel. In an aspect, operation 1802 may be performed by the one or more WWAN transceivers 310, the one or more processors 332, memory 340, and/or sidelink component 342, any or all of which may be considered means for performing this operation.

At operation 1804, the UE decrypts one or more transport blocks of the plurality of transport blocks to provide decrypted payload data. In an aspect, operation 1804 may be performed by the one or more WWAN transceivers 310, the one or more processors 332, memory 340, and/or sidelink component 342, any or all of which may be considered means for performing this operation.

At operation 1806, the UE selects bits of the decrypted payload data based on bit selection criteria. In an aspect, operation 1806 may be performed by the one or more WWAN transceivers 310, the one or more processors 332, memory 340, and/or sidelink component 342, any or all of which may be considered means for performing this operation.

At operation 1808, the UE generates a secret key using the selected bits of the decrypted payload data. In an aspect, operation 1808 may be performed by the one or more WWAN transceivers 310, the one or more processors 332, memory 340, and/or sidelink component 342, any or all of which may be considered means for performing this operation.

At operation 1810, the UE receives encrypted configuration data. In an aspect, operation 1810 may be performed by the one or more WWAN transceivers 310, the one or more processors 332, memory 340, and/or sidelink component 342, any or all of which may be considered means for performing this operation.

At operation 1812, the UE decrypts the encrypted configuration data using the secret key. In an aspect, operation 1812 may be performed by the one or more WWAN transceivers 310, the one or more processors 332, memory 340, and/or sidelink component 342, any or all of which may be considered means for performing this operation.

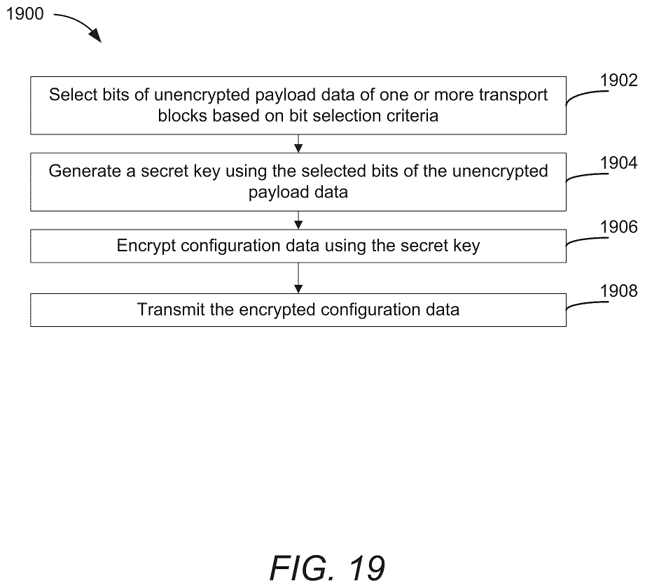

FIG. 19 illustrates an example method 1900 of wireless communication performed by a UE, according to aspects of the disclosure. At operation 1902, the UE selects bits of payload data of one or more transport blocks based on bit selection criteria. In an aspect, operation 1902 may be performed by the one or more WWAN transceivers 310, the one or more processors 332, memory 340, and/or sidelink component 342, any or all of which may be considered means for performing this operation.

At operation 1904, the UE generates a secret key using the selected bits of payload data. In an aspect, operation 1904 may be performed by the one or more WWAN transceivers 310, the one or more processors 332, memory 340, and/or sidelink component 342, any or all of which may be considered means for performing this operation.

At operation 1906, the UE encrypts configuration data using the secret key. In an aspect, operation 1906 may be performed by the one or more WWAN transceivers 310, the one or more processors 332, memory 340, and/or sidelink component 342, any or all of which may be considered means for performing this operation.

At operation 1908, the UE transmits the encrypted configuration data. In an aspect, operation 1908 may be performed by the one or more WWAN transceivers 310, the one or more processors 332, memory 340, and/or sidelink component 342, any or all of which may be considered means for performing this operation.

As will be appreciated, a technical advantage of the methods 1800 and 1900 lies in the fact that the payload data is effectively used for both information transfer and SK generation thereby obviating the need to exchange SK(s) in separate transmissions or on separate transmission resources.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method of wireless communication performed by a user equipment (UE), comprising: receiving a plurality of transport blocks on a physical sidelink shared channel; decrypting one or more transport blocks of the plurality of transport blocks to provide decrypted payload data; selecting bits of the decrypted payload data based on bit selection criteria; generating a secret key using the selected bits of the decrypted payload data; receiving encrypted configuration data; and decrypting the encrypted configuration data using the secret key.

Clause 2. The method of clause 1, wherein the bit selection criteria include: an indication of one or more selected resource elements (REs) carrying data that, after being decrypted, includes the selected bits; an indication of one or more selected resource blocks (RBs) carrying data that, after being decrypted, includes the selected bits; an indication of one or more selected resource block groups (RBGs) carrying data that, after being decrypted, includes the selected bits; an indication of one or more selected symbol occurrences of one or more REs, RBs, or RBGs carrying data that, after being decrypted, includes the selected bits; an indication of one or more selected slots of one or more REs, RBs, or RBGs carrying data that, after being decrypted, includes the selected bits; an indication of one or more patterns corresponding to bits of the decrypted payload data that are to be used as the selected bits; an indication of a bitmap pattern corresponding to which bits of the decrypted payload data are to be used as the selected bits; an indication of one or more selected windows of the one or more transport blocks carrying data that, after being decrypted, includes the selected bits; an indication of one or more start bit and length criteria corresponding to bits of the decrypted payload data are to be used as the selected bits; an indication of which transport blocks of multiple transport blocks are to be used for selection of the selected bits; or any combination thereof.

Clause 3. The method of clause 2, further comprising: receiving an indication of the bit selection criteria via radio resource control (RRC) signaling, one or more media access control-control elements (MAC-CE), or any combination thereof.

Clause 4. The method of clause 3, wherein: the indication of the bit selection criteria is received from a base station.

Clause 5. The method of any of clauses 3 to 4, wherein: the indication of the bit selection criteria is received from a sidelink device.

Clause 6. The method of any of clauses 1 to 5, wherein the encrypted configuration data includes: sidelink control information (SCI); physical sidelink feedback channel (PSFCH) configuration information; sidelink resource pool configuration information; sidelink positioning resource pool configuration information; sidelink bandwidth part configuration information; positioning assistance data; or any combination thereof.

Clause 7. The method of any of clauses 1 to 6, further comprising: storing multiple transport blocks, wherein the bit selection criteria include an indication of which of the multiple transport blocks are to be used to provide the selected bits of the decrypted payload data for generating the secret key.

Clause 8. The method of clause 7, further comprising: transmitting a capability of the UE to store the multiple transport blocks.

Clause 9. The method of any of clauses 1 to 8, further comprising: receiving an indication of a time at which the secret key is to be used to decrypt the encrypted configuration data.

Clause 10. The method of any of clauses 1 to 9, wherein: the one or more transport blocks include secured layer 3 (L3) payload data; and the selected bits of the decrypted payload data are selected from decrypted L3 payload data.

Clause 11. The method of any of clauses 1 to 10, wherein: the one or more transport blocks include secured layer 2 (L2) payload data; and the selected bits of the decrypted payload data are selected from decrypted L2 payload data.

Clause 12. The method of any of clauses 1 to 11, wherein generating the secret key comprises: using the selected bits of the decrypted payload data as the secret key; providing the selected bits of the decrypted payload data to a secret key derivation function; providing the selected bits of the decrypted payload data to a hash function; providing the selected bits of the decrypted payload data as a seed for a pseudo-random number generator; or any combination thereof.

Clause 13. The method of any of clauses 1 to 12, further comprising: generating multiple secret keys using different sets of bits of the selected bits of the decrypted payload data.

Clause 14. The method of clause 13, further comprising: decrypting the encrypted configuration data using different secret keys of the multiple secret keys based on the encrypted configuration data being received via a unicast transmission, a groupcast transmission, or broadcast transmission.

Clause 15. The method of any of clauses 13 to 14, further comprising: decrypting the encrypted configuration data using different secret keys of the multiple secret keys based on the encrypted configuration data including different sidelink resource pool configurations, different sidelink positioning resource pool configurations, or any combination thereof.

Clause 16. The method of any of clauses 13 to 15, wherein: the multiple secret keys are generated using different sets of the selected bits of the decrypted payload data.

Clause 17. A method of wireless communication performed by a user equipment (UE), comprising: selecting bits of unencrypted payload data of one or more transport blocks based on bit selection criteria; generating a secret key using the selected bits of the unencrypted payload data; encrypting configuration data using the secret key; and transmitting the encrypted configuration data.

Clause 18. The method of clause 17, wherein the bit selection criteria include: an indication of one or more selected resource elements (REs) carrying data that, after being decrypted, includes the selected bits; an indication of one or more selected resource blocks (RBs) carrying data that, after being decrypted, includes the selected bits; an indication of one or more selected resource block groups (RBGs) carrying data that, after being decrypted, includes the selected bits; an indication of one or more selected symbol occurrences of one or more REs, RBs, or RBGs carrying data that, after being decrypted, includes the selected bits; an indication of one or more selected slots of one or more REs, RBs, or RBGs carrying data that, after being decrypted, includes the selected bits; an indication of one or more patterns corresponding to bits of the unencrypted payload data that are to be used as the selected bits; an indication of a bitmap pattern corresponding to which bits of the unencrypted payload data are to be used as the selected bits; an indication of one or more selected windows of the one or more transport blocks carrying data that, after being decrypted, include the selected bits; an indication of one or more start bit and length criteria corresponding to bits of the unencrypted payload data are to be used as the selected bits; an indication of which transport blocks of multiple transport blocks are to be used for selection of the selected bits; or any combination thereof.

Clause 19. The method of any of clauses 17 to 18, further comprising: transmitting an indication of the bit selection criteria to one or more sidelink devices.

Clause 20. The method of any of clauses 17 to 19, further comprising: receiving an indication of the bit selection criteria from a base station.

Clause 21. The method of any of clauses 17 to 20, further comprising: encrypting the unencrypted payload data; and transmitting the encrypted payload data in one or more transport blocks to one or more UEs.

Clause 22. The method of any of clauses 17 to 21, further comprising: receiving encrypted payload data in one or more transport blocks from one or more base stations; and decrypting the encrypted payload data of the one or more transport blocks received from the one or more base stations to provide the unencrypted payload data.

Clause 23. The method of any of clauses 17 to 22, wherein the encrypted configuration data includes: sidelink control information (SCI); physical sidelink feedback channel (PSFCH) configuration information; sidelink resource pool configuration information; sidelink positioning resource pool configuration information; sidelink bandwidth part configuration information; positioning assistance data; or any combination thereof.

Clause 24. The method of any of clauses 17 to 23, further comprising: generating multiple secret keys using the selected bits of unencrypted payload data; and encrypting the configuration data using different secret keys of the multiple secret keys based on the encrypted configuration data being transmitted via a unicast transmission, a groupcast transmission, or a broadcast transmission.

Clause 25. The method of any of clauses 17 to 24, further comprising: generating multiple secret keys using different sets of bits of the selected bits of the unencrypted payload data; encrypting different sidelink resource pools of the configuration data using different secret keys of the multiple secret keys; encrypting different sidelink positioning resource pools of the configuration data using different secret keys of the multiple secret keys; or any combination thereof.

Clause 26. A user equipment (UE), comprising: a memory; at least one transceiver; and at least one processor communicatively coupled to the memory and the at least one transceiver, the at least one processor configured to: receive, via the at least one transceiver, a plurality of transport blocks on a physical sidelink shared channel; decrypt one or more transport blocks of the plurality of transport blocks to provide decrypted payload data; select bits of the decrypted payload data based on bit selection criteria; generate a secret key using the selected bits of the decrypted payload data; receive, via the at least one transceiver, encrypted configuration data; and decrypt the encrypted configuration data using the secret key.

Clause 27. The UE of clause 26, wherein the bit selection criteria include: an indication of one or more selected resource elements (REs) carrying data that, after being decrypted, includes the selected bits; an indication of one or more selected resource blocks (RBs) carrying data that, after being decrypted, includes the selected bits; an indication of one or more selected resource block groups (RBGs) carrying data that, after being decrypted, includes the selected bits; an indication of one or more selected symbol occurrences of one or more REs, RBs. or RBGs carrying data that, after being decrypted, includes the selected bits; an indication of one or more selected slots of one or more REs, RBs, or RBGs carrying data that, after being decrypted, includes the selected bits; an indication of one or more patterns corresponding to bits of the decrypted payload data that are to be used as the selected bits; an indication of a bitmap pattern corresponding to which bits of the decrypted payload data are to be used as the selected bits; an indication of one or more selected windows of the one or more transport blocks carrying data that, after being decrypted, includes the selected bits; an indication of one or more start bit and length criteria corresponding to bits of the decrypted payload data are to be used as the selected bits; an indication of which transport blocks of multiple transport blocks are to be used for selection of the selected bits; or any combination thereof.

Clause 28. The UE of clause 27, wherein the at least one processor is further configured to: receive, via the at least one transceiver, an indication of the bit selection criteria via radio resource control (RRC) signaling, one or more media access control-control elements (MAC-CE), or any combination thereof.

Clause 29. The UE of clause 28, wherein: the indication of the bit selection criteria is received from abase station.

Clause 30. The UE of any of clauses 28 to 29, wherein: the indication of the bit selection criteria is received from a sidelink device.

Clause 31. The UE of any of clauses 26 to 30, wherein the encrypted configuration data includes: sidelink control information (SCI); physical sidelink feedback channel (PSFCH) configuration information; sidelink resource pool configuration information; sidelink positioning resource pool configuration information; sidelink bandwidth part configuration information; positioning assistance data; or any combination thereof.

Clause 32. The UE of any of clauses 26 to 31, wherein the at least one processor is further configured to: store multiple transport blocks, wherein the bit selection criteria include an indication of which of the multiple transport blocks are to be used to provide the selected bits of the decrypted payload data for generating the secret key.

Clause 33. The UE of clause 32, wherein the at least one processor is further configured to: transmit, via the at least one transceiver, a capability of the UE to store the multiple transport blocks.

Clause 34. The UE of any of clauses 26 to 33, wherein the at least one processor is further configured to: receive, via the at least one transceiver, an indication of a time at which the secret key is to be used to decrypt the encrypted configuration data.

Clause 35. The UE of any of clauses 26 to 34, wherein: the one or more transport blocks include secured layer 3 (L3) payload data; and the selected bits of the decrypted payload data are selected from decrypted L3 payload data.

Clause 36. The UE of any of clauses 26 to 35, wherein: the one or more transport blocks include secured layer 2 (L2) payload data; and the selected bits of the decrypted payload data are selected from decrypted L2 payload data.

Clause 37. The UE of any of clauses 26 to 36, wherein the at least one processor configured to generate the secret key comprises the at least one processor configured to: use the selected bits of the decrypted payload data as the secret key; provide the selected bits of the decrypted payload data to a secret key derivation function; provide the selected bits of the decrypted payload data to a hash function; provide the selected bits of the decrypted payload data as a seed for a pseudo-random number generator; or any combination thereof.

Clause 38. The UE of any of clauses 26 to 37, wherein the at least one processor is further configured to: generate multiple secret keys using different sets of bits of the selected bits of the decrypted payload data.

Clause 39. The UE of clause 38, wherein the at least one processor is further configured to: decrypt the encrypted configuration data using different secret keys of the multiple secret keys based on the encrypted configuration data being received via a unicast transmission, a groupcast transmission, or broadcast transmission.

Clause 40. The UE of any of clauses 38 to 39, wherein the at least one processor is further configured to: decrypt the encrypted configuration data using different secret keys of the multiple secret keys based on the encrypted configuration data including different sidelink resource pool configurations, different sidelink positioning resource pool configurations, or any combination thereof.

Clause 41. The UE of any of clauses 38 to 40, wherein: the multiple secret keys are generated using different sets of the selected bits of the decrypted payload data.

Clause 42. A user equipment (UE), comprising: a memory; at least one transceiver; and at least one processor communicatively coupled to the memory and the at least one transceiver, the at least one processor configured to: select bits of unencrypted payload data of one or more transport blocks based on bit selection criteria; generate a secret key using the selected bits of the unencrypted payload data; encrypt configuration data using the secret key; and transmit, via the at least one transceiver, the encrypted configuration data.

Clause 43. The UE of clause 42, wherein the bit selection criteria include: an indication of one or more selected resource elements (REs) carrying data that, after being decrypted, includes the selected bits; an indication of one or more selected resource blocks (RBs) carrying data that, after being decrypted, includes the selected bits; an indication of one or more selected resource block groups (RBGs) carrying data that, after being decrypted, includes the selected bits; an indication of one or more selected symbol occurrences of one or more REs, RBs, or RBGs carrying data that, after being decrypted, includes the selected bits; an indication of one or more selected slots of one or more REs, RBs, or RBGs carrying data that, after being decrypted, includes the selected bits; an indication of one or more patterns corresponding to bits of the unencrypted payload data that are to be used as the selected bits; an indication of a bitmap pattern corresponding to which bits of the unencrypted payload data are to be used as the selected bits; an indication of one or more selected windows of the one or more transport blocks carrying data that, after being decrypted, include the selected bits; an indication of one or more start bit and length criteria corresponding to bits of the unencrypted payload data are to be used as the selected bits; an indication of which transport blocks of multiple transport blocks are to be used for selection of the selected bits; or any combination thereof.

Clause 44. The UE of any of clauses 42 to 43, wherein the at least one processor is further configured to: transmit, via the at least one transceiver, an indication of the bit selection criteria to one or more sidelink devices.

Clause 45. The UE of any of clauses 42 to 44, wherein the at least one processor is further configured to: receive, via the at least one transceiver, an indication of the bit selection criteria from a base station.

Clause 46. The UE of any of clauses 42 to 45, wherein the at least one processor is further configured to: encrypt the unencrypted payload data; and transmit, via the at least one transceiver, the encrypted payload data in one or more transport blocks to one or more UEs.

Clause 47. The UE of any of clauses 42 to 46, wherein the at least one processor is further configured to: receive, via the at least one transceiver, encrypted payload data in one or more transport blocks from one or more base stations; and decrypt the encrypted payload data of the one or more transport blocks received from the one or more base stations to provide the unencrypted payload data.

Clause 48. The UE of any of clauses 42 to 47, wherein the encrypted configuration data includes: sidelink control information (SCI); physical sidelink feedback channel (PSFCH) configuration information; sidelink resource pool configuration information; sidelink positioning resource pool configuration information; sidelink bandwidth part configuration information; positioning assistance data; or any combination thereof.

Clause 49. The UE of any of clauses 42 to 48, wherein the at least one processor is further configured to: generate multiple secret keys using the selected bits of unencrypted payload data; and encrypt the configuration data using different secret keys of the multiple secret keys based on the encrypted configuration data being transmitted via a unicast transmission, a groupcast transmission, or a broadcast transmission.

Clause 50. The UE of any of clauses 42 to 49, wherein the at least one processor is further configured to: generate multiple secret keys using different sets of bits of the selected bits of the unencrypted payload data; encrypt different sidelink resource pools of the configuration data using different secret keys of the multiple secret keys; encrypt different sidelink positioning resource pools of the configuration data using different secret keys of the multiple secret keys; or any combination thereof.

Clause 51. A user equipment (UE), comprising: means for receiving a plurality of transport blocks on a physical sidelink shared channel; means for decrypting one or more transport blocks of the plurality of transport blocks to provide decrypted payload data; means for selecting bits of the decrypted payload data based on bit selection criteria; means for generating a secret key using the selected bits of the decrypted payload data; means for receiving encrypted configuration data; and means for decrypting the encrypted configuration data using the secret key.

Clause 52. The UE of clause 51, wherein the bit selection criteria include: an indication of one or more selected resource elements (REs) carrying data that, after being decrypted, includes the selected bits; an indication of one or more selected resource blocks (RBs) carrying data that, after being decrypted, includes the selected bits; an indication of one or more selected resource block groups (RBGs) carrying data that, after being decrypted, includes the selected bits; an indication of one or more selected symbol occurrences of one or more REs, RBs, or RBGs carrying data that, after being decrypted, includes the selected bits; an indication of one or more selected slots of one or more REs, RBs, or RBGs carrying data that, after being decrypted, includes the selected bits; an indication of one or more patterns corresponding to bits of the decrypted payload data that are to be used as the selected bits; an indication of a bitmap pattern corresponding to which bits of the decrypted payload data are to be used as the selected bits; an indication of one or more selected windows of the one or more transport blocks carrying data that, after being decrypted, includes the selected bits; an indication of one or more start bit and length criteria corresponding to bits of the decrypted payload data are to be used as the selected bits; an indication of which transport blocks of multiple transport blocks are to be used for selection of the selected bits; or any combination thereof.

Clause 53. The UE of clause 52, further comprising: means for receiving an indication of the bit selection criteria via radio resource control (RRC) signaling, one or more media access control-control elements (MAC-CE), or any combination thereof.

Clause 54. The UE of clause 53, wherein: the indication of the bit selection criteria is received from a base station.

Clause 55. The UE of any of clauses 53 to 54, wherein: the indication of the bit selection criteria is received from a sidelink device.

Clause 56. The UE of any of clauses 51 to 55, wherein the encrypted configuration data includes: sidelink control information (SCI); physical sidelink feedback channel (PSFCH) configuration information; sidelink resource pool configuration information; sidelink positioning resource pool configuration information; sidelink bandwidth part configuration information; positioning assistance data; or any combination thereof.

Clause 57. The UE of any of clauses 51 to 56, further comprising: means for storing multiple transport blocks, wherein the bit selection criteria include an indication of which of the multiple transport blocks are to be used to provide the selected bits of the decrypted payload data for generating the secret key.

Clause 58. The UE of clause 57, further comprising: means for transmitting a capability of the UE to store the multiple transport blocks.

Clause 59. The UE of any of clauses 51 to 58, further comprising: means for receiving an indication of a time at which the secret key is to be used to decrypt the encrypted configuration data.

Clause 60. The UE of any of clauses 51 to 59, wherein: the one or more transport blocks include secured layer 3 (L3) payload data; and the selected bits of the decrypted payload data are selected from decrypted L3 payload data.

Clause 61. The UE of any of clauses 51 to 60, wherein: the one or more transport blocks include secured layer 2 (L2) payload data; and the selected bits of the decrypted payload data are selected from decrypted L2 payload data.

Clause 62. The UE of any of clauses 51 to 61, wherein the means for generating the secret key comprises: means for using the selected bits of the decrypted payload data as the secret key; means for providing the selected bits of the decrypted payload data to a secret key derivation function; means for providing the selected bits of the decrypted payload data to a hash function; means for providing the selected bits of the decrypted payload data as a seed for a pseudo-random number generator; or any combination thereof.

Clause 63. The UE of any of clauses 51 to 62, further comprising: means for generating multiple secret keys using different sets of bits of the selected bits of the decrypted payload data.

Clause 64. The UE of clause 63, further comprising: means for decrypting the encrypted configuration data using different secret keys of the multiple secret keys based on the encrypted configuration data being received via a unicast transmission, a groupcast transmission, or broadcast transmission.

Clause 65. The UE of any of clauses 63 to 64, further comprising: means for decrypting the encrypted configuration data using different secret keys of the multiple secret keys based on the encrypted configuration data including different sidelink resource pool configurations, different sidelink positioning resource pool configurations, or any combination thereof.

Clause 66. The UE of any of clauses 63 to 65, wherein: the multiple secret keys are generated using different sets of the selected bits of the decrypted payload data.

Clause 67. A user equipment (UE), comprising: means for selecting bits of unencrypted payload data of one or more transport blocks based on bit selection criteria; means for generating a secret key using the selected bits of the unencrypted payload data; means for encrypting configuration data using the secret key; and means for transmitting the encrypted configuration data.

Clause 68. The UE of clause 67, wherein the bit selection criteria include: an indication of one or more selected resource elements (REs) carrying data that, after being decrypted, includes the selected bits; an indication of one or more selected resource blocks (RBs) carrying data that, after being decrypted, includes the selected bits; an indication of one or more selected resource block groups (RBGs) carrying data that, after being decrypted, includes the selected bits; an indication of one or more selected symbol occurrences of one or more REs, RBs, or RBGs carrying data that, after being decrypted, includes the selected bits; an indication of one or more selected slots of one or more REs, RBs, or RBGs carrying data that, after being decrypted, includes the selected bits; an indication of one or more patterns corresponding to bits of the unencrypted payload data that are to be used as the selected bits; an indication of a bitmap pattern corresponding to which bits of the unencrypted payload data are to be used as the selected bits; an indication of one or more selected windows of the one or more transport blocks carrying data that, after being decrypted, include the selected bits; an indication of one or more start bit and length criteria corresponding to bits of the unencrypted payload data are to be used as the selected bits; an indication of which transport blocks of multiple transport blocks are to be used for selection of the selected bits; or any combination thereof.

Clause 69. The UE of any of clauses 67 to 68, further comprising: means for transmitting an indication of the bit selection criteria to one or more sidelink devices.

Clause 70. The UE of any of clauses 67 to 69, further comprising: means for receiving an indication of the bit selection criteria from a base station.

Clause 71. The UE of any of clauses 67 to 70, further comprising: means for encrypting the unencrypted payload data; and means for transmitting the encrypted payload data in one or more transport blocks to one or more UEs.

Clause 72. The UE of any of clauses 67 to 71, further comprising: means for receiving encrypted payload data in one or more transport blocks from one or more base stations; and means for decrypting the encrypted payload data of the one or more transport blocks received from the one or more base stations to provide the unencrypted payload data.

Clause 73. The UE of any of clauses 67 to 72, wherein the encrypted configuration data includes: sidelink control information (SCI); physical sidelink feedback channel (PSFCH) configuration information; sidelink resource pool configuration information; sidelink positioning resource pool configuration information; sidelink bandwidth part configuration information; positioning assistance data; or any combination thereof.

Clause 74. The UE of any of clauses 67 to 73, further comprising: means for generating multiple secret keys using the selected bits of unencrypted payload data; and means for encrypting the configuration data using different secret keys of the multiple secret keys based on the encrypted configuration data being transmitted via a unicast transmission, a groupcast transmission, or a broadcast transmission.

Clause 75. The UE of any of clauses 67 to 74, further comprising: means for generating multiple secret keys using different sets of bits of the selected bits of the unencrypted payload data; means for encrypting different sidelink resource pools of the configuration data using different secret keys of the multiple secret keys; means for encrypting different sidelink positioning resource pools of the configuration data using different secret keys of the multiple secret keys; or any combination thereof.

Clause 76. A non-transitory computer-readable medium storing computer-executable instructions that, when executed by a user equipment (UE), cause the UE to: receive a plurality of transport blocks on a physical sidelink shared channel; decrypt one or more transport blocks of the plurality of transport blocks to provide decrypted payload data; select bits of the decrypted payload data based on bit selection criteria; generate a secret key using the selected bits of the decrypted payload data; receive encrypted configuration data; and decrypt the encrypted configuration data using the secret key.

Clause 77. The non-transitory computer-readable medium of clause 76, wherein the bit selection criteria include: an indication of one or more selected resource elements (REs) carrying data that, after being decrypted, includes the selected bits; an indication of one or more selected resource blocks (RBs) carrying data that, after being decrypted, includes the selected bits; an indication of one or more selected resource block groups (RBGs) carrying data that, after being decrypted, includes the selected bits; an indication of one or more selected symbol occurrences of one or more REs, RBs, or RBGs carrying data that, after being decrypted, includes the selected bits; an indication of one or more selected slots of one or more REs, RBs, or RBGs carrying data that, after being decrypted, includes the selected bits; an indication of one or more patterns corresponding to bits of the decrypted payload data that are to be used as the selected bits; an indication of a bitmap pattern corresponding to which bits of the decrypted payload data are to be used as the selected bits; an indication of one or more selected windows of the one or more transport blocks carrying data that, after being decrypted, includes the selected bits; an indication of one or more start bit and length criteria corresponding to bits of the decrypted payload data are to be used as the selected bits; an indication of which transport blocks of multiple transport blocks are to be used for selection of the selected bits; or any combination thereof.

Clause 78. The non-transitory computer-readable medium of clause 77, further comprising computer-executable instructions that, when executed by the UE, cause the UE to: receive an indication of the bit selection criteria via radio resource control (RRC) signaling, one or more media access control-control elements (MAC-CE), or any combination thereof.

Clause 79. The non-transitory computer-readable medium of clause 78, wherein: the indication of the bit selection criteria is received from a base station.

Clause 80. The non-transitory computer-readable medium of any of clauses 78 to 79, wherein: the indication of the bit selection criteria is received from a sidelink device.

Clause 81. The non-transitory computer-readable medium of any of clauses 76 to 80, wherein the encrypted configuration data includes: sidelink control information (SCI); physical sidelink feedback channel (PSFCH) configuration information; sidelink resource pool configuration information; sidelink positioning resource pool configuration information; sidelink bandwidth part configuration information; positioning assistance data; or any combination thereof.

Clause 82. The non-transitory computer-readable medium of any of clauses 76 to 81, further comprising computer-executable instructions that, when executed by the UE, cause the UE to: store multiple transport blocks, wherein the bit selection criteria include an indication of which of the multiple transport blocks are to be used to provide the selected bits of the decrypted payload data for generating the secret key.

Clause 83. The non-transitory computer-readable medium of clause 82, further comprising computer-executable instructions that, when executed by the UE, cause the UE to: transmit a capability of the UE to store the multiple transport blocks.

Clause 84. The non-transitory computer-readable medium of any of clauses 76 to 83, further comprising computer-executable instructions that, when executed by the UE, cause the UE to: receive an indication of a time at which the secret key is to be used to decrypt the encrypted configuration data.

Clause 85. The non-transitory computer-readable medium of any of clauses 76 to 84, wherein: the one or more transport blocks include secured layer 3 (L3) payload data; and the selected bits of the decrypted payload data are selected from decrypted L3 payload data.

Clause 86. The non-transitory computer-readable medium of any of clauses 76 to 85, wherein: the one or more transport blocks include secured layer 2 (L2) payload data; and the selected bits of the decrypted payload data are selected from decrypted L2 payload data.

Clause 87. The non-transitory computer-readable medium of any of clauses 76 to 86, wherein the computer-executable instructions that, when executed by the UE, cause the UE: use the selected bits of the decrypted payload data as the secret key; provide the selected bits of the decrypted payload data to a secret key derivation function; provide the selected bits of the decrypted payload data to a hash function; provide the selected bits of the decrypted payload data as a seed for a pseudo-random number generator; or any combination thereof.

Clause 88. The non-transitory computer-readable medium of any of clauses 76 to 87, further comprising computer-executable instructions that, when executed by the UE, cause the UE to: generate multiple secret keys using different sets of bits of the selected bits of the decrypted payload data.

Clause 89. The non-transitory computer-readable medium of clause 88, further comprising computer-executable instructions that, when executed by the UE, cause the UE to: decrypt the encrypted configuration data using different secret keys of the multiple secret keys based on the encrypted configuration data being received via a unicast transmission, a groupcast transmission, or broadcast transmission.

Clause 90. The non-transitory computer-readable medium of any of clauses 88 to 89, further comprising computer-executable instructions that, when executed by the UE, cause the UE to: decrypt the encrypted configuration data using different secret keys of the multiple secret keys based on the encrypted configuration data including different sidelink resource pool configurations, different sidelink positioning resource pool configurations, or any combination thereof.

Clause 91. The non-transitory computer-readable medium of any of clauses 88 to 90, wherein: the multiple secret keys are generated using different sets of the selected bits of the decrypted payload data.

Clause 92. A non-transitory computer-readable medium storing computer-executable instructions that, when executed by a user equipment (UE), cause the UE to: select bits of unencrypted payload data of one or more transport blocks based on bit selection criteria; generate a secret key using the selected bits of the unencrypted payload data; encrypt configuration data using the secret key; and transmit the encrypted configuration data.

Clause 93. The non-transitory computer-readable medium of clause 92, wherein the bit selection criteria include: an indication of one or more selected resource elements (REs) carrying data that, after being decrypted, includes the selected bits; an indication of one or more selected resource blocks (RBs) carrying data that, after being decrypted, includes the selected bits; an indication of one or more selected resource block groups (RBGs) carrying data that, after being decrypted, includes the selected bits; an indication of one or more selected symbol occurrences of one or more REs, RBs, or RBGs carrying data that, after being decrypted, includes the selected bits; an indication of one or more selected slots of one or more REs, RBs, or RBGs carrying data that, after being decrypted, includes the selected bits; an indication of one or more patterns corresponding to bits of the unencrypted payload data that are to be used as the selected bits, an indication of a bitmap pattern corresponding to which bits of the unencrypted payload data are to be used as the selected bits; an indication of one or more selected windows of the one or more transport blocks carrying data that, after being decrypted, include the selected bits; an indication of one or more start bit and length criteria corresponding to bits of the unencrypted payload data are to be used as the selected bits; an indication of which transport blocks of multiple transport blocks are to be used for selection of the selected bits; or any combination thereof.

Clause 94. The non-transitory computer-readable medium of any of clauses 92 to 93, further comprising computer-executable instructions that, when executed by the UE, cause the UE to: transmit an indication of the bit selection criteria to one or more sidelink devices.

Clause 95. The non-transitory computer-readable medium of any of clauses 92 to 94, further comprising computer-executable instructions that, when executed by the UE, cause the UE to: receive an indication of the bit selection criteria from a base station.

Clause 96. The non-transitory computer-readable medium of any of clauses 92 to 95, further comprising computer-executable instructions that, when executed by the UE, cause the UE to: encrypt the unencrypted payload data; and transmit the encrypted payload data in one or more transport blocks to one or more UEs.

Clause 97. The non-transitory computer-readable medium of any of clauses 92 to 96, further comprising computer-executable instructions that, when executed by the UE, cause the UE to: receive encrypted payload data in one or more transport blocks from one or more base stations; and decrypt the encrypted payload data of the one or more transport blocks received from the one or more base stations to provide the unencrypted payload data.

Clause 98. The non-transitory computer-readable medium of any of clauses 92 to 97, wherein the encrypted configuration data includes: sidelink control information (SCI); physical sidelink feedback channel (PSFCH) configuration information; sidelink resource pool configuration information; sidelink positioning resource pool configuration information; sidelink bandwidth part configuration information; positioning assistance data; or any combination thereof.

Clause 99. The non-transitory computer-readable medium of any of clauses 92 to 98, further comprising computer-executable instructions that, when executed by the UE, cause the UE to: generate multiple secret keys using the selected bits of unencrypted payload data; and encrypt the configuration data using different secret keys of the multiple secret keys based on the encrypted configuration data being transmitted via a unicast transmission, a groupcast transmission, or a broadcast transmission.

Clause 100. The non-transitory computer-readable medium of any of clauses 92 to 99, further comprising computer-executable instructions that, when executed by the UE, cause the UE to: generate multiple secret keys using different sets of bits of the selected bits of the unencrypted payload data; encrypt different sidelink resource pools of the configuration data using different secret keys of the multiple secret keys; encrypt different sidelink positioning resource pools of the configuration data using different secret keys of the multiple secret keys; or any combination thereof.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general-purpose processor, a DSP, an ASIC, a FPGA, or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method of wireless communication performed by a user equipment (UE), comprising:
receiving a plurality of transport blocks on a physical sidelink shared channel;
decrypting one or more transport blocks of the plurality of transport blocks to provide decrypted payload data;
selecting bits of the decrypted payload data based on bit selection criteria;
generating a secret key using the selected bits of the decrypted payload data;
receiving encrypted configuration data; and
decrypting the encrypted configuration data using the secret key.

2. The method of claim 1, wherein the bit selection criteria include:
an indication of one or more selected resource elements (REs) carrying data that, after being decrypted, includes the selected bits;
an indication of one or more selected resource blocks (RBs) carrying data that, after being decrypted, includes the selected bits;
an indication of one or more selected resource block groups (RBGs) carrying data that, after being decrypted, includes the selected bits;
an indication of one or more selected symbol occurrences of one or more REs, RBs, or RBGs carrying data that, after being decrypted, includes the selected bits;
an indication of one or more selected slots of one or more REs, RBs, or RBGs carrying data that, after being decrypted, includes the selected bits;
an indication of one or more patterns corresponding to bits of the decrypted payload data that are to be used as the selected bits;
an indication of a bitmap pattern corresponding to which bits of the decrypted payload data are to be used as the selected bits;
an indication of one or more selected windows of the one or more transport blocks carrying data that, after being decrypted, includes the selected bits;
an indication of one or more start bit and length criteria corresponding to bits of the decrypted payload data are to be used as the selected bits;
an indication of which transport blocks of multiple transport blocks are to be used for selection of the selected bits; or
any combination thereof.

3. The method of claim 2, further comprising:
receiving an indication of the bit selection criteria via radio resource control (RRC) signaling, one or more media access control-control elements (MAC-CE), or any combination thereof.

4. The method of claim 3, wherein:
the indication of the bit selection criteria is received from a base station.

5. The method of claim 3, wherein:
the indication of the bit selection criteria is received from a sidelink device.

6. The method of claim 1, wherein the encrypted configuration data includes:
sidelink control information (SCI);
physical sidelink feedback channel (PSFCH) configuration information;
sidelink resource pool configuration information;
sidelink positioning resource pool configuration information;
sidelink bandwidth part configuration information;
positioning assistance data; or
any combination thereof.

7. The method of claim 1, further comprising:
storing multiple transport blocks, wherein the bit selection criteria include an indication of which of the multiple transport blocks are to be used to provide the selected bits of the decrypted payload data for generating the secret key.

8. The method of claim 7, further comprising:
transmitting a capability of the UE to store the multiple transport blocks.

9. The method of claim 1, further comprising:
receiving an indication of a time at which the secret key is to be used to decrypt the encrypted configuration data.

10. The method of claim 1, wherein:
the one or more transport blocks include secured layer 3 (L3) payload data; and
the selected bits of the decrypted payload data are selected from decrypted L3 payload data.

11. The method of claim 1, wherein:
the one or more transport blocks include secured layer 2 (L2) payload data; and
the selected bits of the decrypted payload data are selected from decrypted L2 payload data.

12. The method of claim 1, wherein generating the secret key comprises:
using the selected bits of the decrypted payload data as the secret key;
providing the selected bits of the decrypted payload data to a secret key derivation function;
providing the selected bits of the decrypted payload data to a hash function;
providing the selected bits of the decrypted payload data as a seed for a pseudo-random number generator; or
any combination thereof.

13. The method of claim 1, further comprising:
generating multiple secret keys using different sets of bits of the selected bits of the decrypted payload data.

14. The method of claim 13, further comprising:
decrypting the encrypted configuration data using different secret keys of the multiple secret keys based on the encrypted configuration data being received via a unicast transmission, a groupcast transmission, or broadcast transmission.

15. The method of claim 13, further comprising:
decrypting the encrypted configuration data using different secret keys of the multiple secret keys based on the encrypted configuration data including
different sidelink resource pool configurations,
different sidelink positioning resource pool configurations, or
any combination thereof.

16. The method of claim 13, wherein:
the multiple secret keys are generated using different sets of the selected bits of the decrypted payload data.

17. A method of wireless communication performed by a user equipment (UE), comprising:
selecting bits of unencrypted payload data of one or more transport blocks based on bit selection criteria;
generating a secret key using the selected bits of the unencrypted payload data;
encrypting configuration data using the secret key; and
transmitting the encrypted configuration data.

18. The method of claim 17, wherein the bit selection criteria include:
an indication of one or more selected resource elements (REs) carrying data that, after being decrypted, includes the selected bits;
an indication of one or more selected resource blocks (RBs) carrying data that, after being decrypted, includes the selected bits;
an indication of one or more selected resource block groups (RBGs) carrying data that, after being decrypted, includes the selected bits;
an indication of one or more selected symbol occurrences of one or more REs, RBs, or RBGs carrying data that, after being decrypted, includes the selected bits;
an indication of one or more selected slots of one or more REs, RBs, or RBGs carrying data that, after being decrypted, includes the selected bits;
an indication of one or more patterns corresponding to bits of the unencrypted payload data that are to be used as the selected bits;
an indication of a bitmap pattern corresponding to which bits of the unencrypted payload data are to be used as the selected bits;
an indication of one or more selected windows of the one or more transport blocks carrying data that, after being decrypted, include the selected bits;
an indication of one or more start bit and length criteria corresponding to bits of the unencrypted payload data are to be used as the selected bits;
an indication of which transport blocks of multiple transport blocks are to be used for selection of the selected bits; or
any combination thereof.

19. The method of claim 17, further comprising:
transmitting an indication of the bit selection criteria to one or more sidelink devices.

20. The method of claim 17, further comprising:
receiving an indication of the bit selection criteria from a base station.

21. The method of claim 17, further comprising:
encrypting the unencrypted payload data; and
transmitting the encrypted payload data in one or more transport blocks to one or more UEs.

22. The method of claim 17, further comprising:
receiving encrypted payload data in one or more transport blocks from one or more base stations; and
decrypting the encrypted payload data of the one or more transport blocks received from the one or more base stations to provide the unencrypted payload data.

23. The method of claim 17, wherein the encrypted configuration data includes:
sidelink control information (SCI);
physical sidelink feedback channel (PSFCH) configuration information;
sidelink resource pool configuration information;
sidelink positioning resource pool configuration information;
sidelink bandwidth part configuration information;
positioning assistance data; or
any combination thereof.

24. The method of claim 17, further comprising:
generating multiple secret keys using the selected bits of unencrypted payload data; and
encrypting the configuration data using different secret keys of the multiple secret keys based on the encrypted configuration data being transmitted via a unicast transmission, a groupcast transmission, or a broadcast transmission.

25. The method of claim 17, further comprising:
generating multiple secret keys using different sets of bits of the selected bits of the unencrypted payload data;
encrypting different sidelink resource pools of the configuration data using different secret keys of the multiple secret keys;
encrypting different sidelink positioning resource pools of the configuration data using different secret keys of the multiple secret keys; or
any combination thereof.

26. A user equipment (UE), comprising:
a memory;
at least one transceiver; and
at least one processor communicatively coupled to the memory and the at least one transceiver, the at least one processor configured to:
receive, via the at least one transceiver, a plurality of transport blocks on a physical sidelink shared channel;
decrypt one or more transport blocks of the plurality of transport blocks to provide decrypted payload data;
select bits of the decrypted payload data based on bit selection criteria;
generate a secret key using the selected bits of the decrypted payload data;
receive, via the at least one transceiver, encrypted configuration data; and
decrypt the encrypted configuration data using the secret key.

27. The UE of claim 26, wherein the bit selection criteria include:
an indication of one or more selected resource elements (REs) carrying data that, after being decrypted, includes the selected bits;
an indication of one or more selected resource blocks (RBs) carrying data that, after being decrypted, includes the selected bits;
an indication of one or more selected resource block groups (RBGs) carrying data that, after being decrypted, includes the selected bits;
an indication of one or more selected symbol occurrences of one or more REs, RBs, or RBGs carrying data that, after being decrypted, includes the selected bits;
an indication of one or more selected slots of one or more REs, RBs, or RBGs carrying data that, after being decrypted, includes the selected bits;
an indication of one or more patterns corresponding to bits of the decrypted payload data that are to be used as the selected bits;
an indication of a bitmap pattern corresponding to which bits of the decrypted payload data are to be used as the selected bits;
an indication of one or more selected windows of the one or more transport blocks carrying data that, after being decrypted, includes the selected bits;
an indication of one or more start bit and length criteria corresponding to bits of the decrypted payload data are to be used as the selected bits;
an indication of which transport blocks of multiple transport blocks are to be used for selection of the selected bits; or
any combination thereof.

28. The UE of claim 26, wherein the encrypted configuration data includes:
sidelink control information (SCI);
physical sidelink feedback channel (PSFCH) configuration information;
sidelink resource pool configuration information;
sidelink positioning resource pool configuration information;
sidelink bandwidth part configuration information;
positioning assistance data; or
any combination thereof.

29. A user equipment (UE), comprising:
a memory;
at least one transceiver; and
at least one processor communicatively coupled to the memory and the at least one transceiver, the at least one processor configured to:
select bits of unencrypted payload data of one or more transport blocks based on bit selection criteria;
generate a secret key using the selected bits of the unencrypted payload data;
encrypt configuration data using the secret key; and
transmit, via the at least one transceiver, the encrypted configuration data.

30. The UE of claim 29, wherein the bit selection criteria include:
an indication of one or more selected resource elements (REs) carrying data that, after being decrypted, includes the selected bits;
an indication of one or more selected resource blocks (RBs) carrying data that, after being decrypted, includes the selected bits;
an indication of one or more selected resource block groups (RBGs) carrying data that, after being decrypted, includes the selected bits;
an indication of one or more selected symbol occurrences of one or more REs, RBs, or RBGs carrying data that, after being decrypted, includes the selected bits;
an indication of one or more selected slots of one or more REs, RBs, or RBGs carrying data that, after being decrypted, includes the selected bits;
an indication of one or more patterns corresponding to bits of the unencrypted payload data that are to be used as the selected bits;
an indication of a bitmap pattern corresponding to which bits of the unencrypted payload data are to be used as the selected bits;
an indication of one or more selected windows of the one or more transport blocks carrying data that, after being decrypted, include the selected bits;
an indication of one or more start bit and length criteria corresponding to bits of the unencrypted payload data are to be used as the selected bits;
an indication of which transport blocks of multiple transport blocks are to be used for selection of the selected bits; or
any combination thereof.
